(19) United States
(12) Patent Application Publication
(10) Pub. No.: US 2007/0058314 A1
(43) Pub. Date: Mar. 15, 2007

(54) Controlling spas

(76) Inventor: Harold D. Maddox, Santa Maria, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(21) Appl. No.: 11/530,440

(22) Filed: Sep. 8, 2006

Related U.S. Application Data
(60) Provisional application No. 60/715,925, filed on Sep. 9, 2005.
(60) Provisional application No. 60/748,761, filed on Dec. 8, 2005.

(51) Int. Cl. H02H 5/04

(52) U.S. Cl. 361/103

(57) ABSTRACT

A spa control system, the spa control system comprising a processor, wherein the processor is adapted to provide a signal to a user interface representing a spa operation. The user interface coupled to the processor, the user interface comprising a display, wherein the display can comprise of various display technology and is adapted to provide a user understandable data representing the spa operation. The spa control system utilizing electrical current sensors and temperature sensors to operate spa functions.

This application is a non-provisional of U.S. Provisional Application No. 60/715,925, filed Sep. 9, 2005, entitled “SPA CONTROL CONNECTOR” to Maddox, and U.S. Provisional Application No. 60/748,761, filed Dec. 8, 2005, entitled “SPA CONTROLS AND RELATED COMPONENTS” to Maddox, both of which are incorporated in their entirety herein by reference.

### BACKGROUND

1. Field of Invention

Embodiments of the present invention relate generally to spas, and more specifically, embodiments of the present invention relate to systems and methods for controlling spa functions and spa operation.

2. Discussion of the Related Art

Spas are popular fixtures that are used in many homes and hotels. They include a large tub or small pool of heated water and used for soaking and relaxation. Many spas further include water jets for massage purposes. Spas usually have several independent water circuits with one providing heating and filtration and the others driving the water jets and blowers. Spas usually also have a user control panel for the purpose of providing information about spa operations to a user and for the user to control various spa functions. Spas typically include safety features to protect the user and to maintain spa functionality.

While there are various spa control systems available, they are not able to adapt to various display technology without having to change a control processor in a control unit. Conventional spa circuitry usually involves a multitude of wires and the necessity to access a control unit housing to connect the control unit to a spa device. Typical spa control systems also rely on switches to provide data to the control unit and the control processor. Currently spa control systems do not provide a user with electrical current setting options, nor do they use electrical current sensors and temperature sensors to provide self testing and protection functions. The spa control systems currently available do not take advantage of cooler temperatures at night and warmer temperatures during the day to efficiently manage a spa temperature. Because of the complexity of spa functions, various safety issues and standards, and a multitude of spa operation information, it is desirable to have an improved apparatus for controlling spas.

### SUMMARY OF THE ILLUSTRATED EMBODIMENTS

In accordance with one embodiment, the present invention can be characterized as a spa control system, the spa control system with a processor, such as a microcontroller, wherein the processor is adapted to provide a signal to a user interface representing a spa operation, a user interface that is coupled to the processor, where the user interface comprising a display, wherein the display can comprise of various display technology and is adapted to provide a user understandable data representing the spa operation, and a means for the user interface to convert the signal representing the spa operation to a signal that the display can convert to the user understandable data representing the spa operation.

In accordance with yet another embodiment, the present invention can be characterized as a spa control system with an incoming power line, wherein the incoming power line is adapted to provide an electrical current for at least one spa device, a user interface coupled with the incoming power line, the user interface comprising a display operative to provide an electrical current amount, and a user manipulatable trigger operative to provide a signal indicating the electrical current amount.

In accordance with a further embodiment, the present invention can be characterized as a spa control system with an incoming power line, wherein the incoming power line is adapted to provide an electrical current for at least one spa device, an electrical current sensor coupled to the incoming power line, wherein the electrical current sensor is adapted to provide an electrical current amount data representing an electrical current flow through the incoming power line, a user interface coupled with the incoming power line, the user interface comprising a display operative to provide the electrical current amount data, and a user manipulatable trigger operative to provide a signal indicating the electrical current amount data.

In accordance with an additional embodiment, the present invention can be characterized as a spa control system with an incoming power line, at least one spa device coupled to the incoming power line, an electrical current sensor coupled to the incoming power line, wherein the electrical current sensor is adapted to provide an electrical current amount data representing an electrical current flow through the incoming power line, a memory device coupled to the electrical current sensor, wherein the memory device is adapted to store the electrical current amount data and an electrical current amount for a proper operation of the spa device and a processor coupled to the memory device, wherein the processor is adapted to detect the electrical current amount data is not the electrical current amount for the proper operation of the spa device provide a signal indicating the electrical current amount data is not the electrical current amount for the proper operation of the spa device.

In accordance with another additional embodiment, the present invention can be characterized as a spa control system with an electrical relay board, a temperature sensor operative to provide a temperature amount data, wherein the temperature amount data represents a temperature of the electrical relay board, a processor coupled to the temperature sensor, wherein the processor is adapted to receive the temperature amount data, detect that the temperature amount data is not an amount for a proper electrical relay board operation, and provide a signal indicating the temperature amount data is not the amount for the proper electrical relay board operation.

In accordance with yet a further embodiment, the present invention can be characterized as a spa control system with a spa water heater, a temperature sensor operative to provide a temperature amount data representing a temperature of the spa water heater, and a processor coupled to the temperature sensor, wherein the processor is adapted to compute a time to begin a heat cycle, the processor computing the time to begin the heat cycle based upon the temperature amount data.

In accordance with another further embodiment, the present invention can be characterized as a spa control system with a user interface, the user interface comprising a plurality of user manipulatable triggers, and a processor coupled to the user interface, the processor adapted to control a spa device and/or a spa device level of operation based upon a particular sequence of activation of the user manipulatable triggers.

In accordance with yet an additional embodiment, the present invention can be characterized as a spa control system with a user interface, the user interface comprising a user manipulatable trigger operative to provide a signal indicating a user manipulation of the user manipulatable trigger a display operative to provide a data representing a spa device and a processor coupled to the user interface, the processor adapted to control a spa device based upon the activation of the user manipulatable triggers when the display provides the data representing the spa device.

In accordance with a further additional embodiment, the present invention can be characterized as a spa control system with a user interface, the user interface comprising a user manipulatable trigger operative to provide a continuous signal indicating a continuous user manipulation of the user manipulatable trigger, a display operative to provide a data representing a temperature amount for a spa operation, a processor coupled to the user interface, the processor adapted to receive the continuous signal indicating the continuous user manipulation of the user manipulatable trigger, and increment and decrement continuously the data representing the temperature amount for the spa operation when the continuous signal is received.

In accordance with yet another further embodiment, the present invention can be characterized as a spa control system with a user interface, the user interface with a portable device that has a power source adapted to generate power to the portable device with light energy.

In accordance with yet a further additional embodiment, the present invention can be characterized as a spa control system with a control module, and a stepdown transformer coupled to the control module, wherein the stepdown transformer is adapted to provide power to the control module.

In accordance with yet another farther embodiment, the present invention can be characterized as a spa control system with a first processor, wherein the first processor is adapted to control a spa device operation, and a second processor, wherein the second process is adapted to control the spa device operation.

In accordance with another embodiment, the present invention can be characterized as a spa control system with a processor, wherein the processor is adapted to control a spa water heater device a sensor housing coupled to the processor, the sensor housing comprising a first temperature sensor operative to provide a first temperature amount data representing a temperature of the spa water heater device to the processor, and a second temperature sensor operative to provide a second temperature amount data representing a temperature of the spa water heater device to the processor.

In accordance with another embodiment, the present invention can be characterized as a spa control system with a temperature sensor operative to provide a temperature amount data of a spa water heater, and a processor coupled to the temperature sensor, wherein the processor is adapted to provide a temperature amount data of a spa main body water based on the temperature amount data of the spa water heater.

In accordance with yet another embodiment, the present invention can be characterized as a spa control system with a spa water heater, a first pump operatively connected to the spa water heater to provide water to a spa water heater, a second pump operatively connected to the spa water heater also to provide water to the spa water heater, a sensor operative to provide a data representing an absence of water in the spa water heater, and a processor coupled to the first pump and the second pump, wherein the processor is adapted to activate the first pump at the beginning of a spa water heater on cycle, detect the data representing the absence of water in the spa water heater, and activate the second pump at the beginning of the spa water heater on cycle when the absence of water in the spa water heater is detected.

In accordance with a supplemental embodiment, the present invention can be characterized as a spa control system with a power line, wherein the power line is adapted to provide an electrical current to a plurality of spa devices, a first spa device coupled to the power line; a second spa device coupled to the power line; and a processor coupled to the first spa device and second spa device, wherein the processor is adapted to reduce the electrical current to the second spa device from a first electrical current amount to a second electrical current amount when the electrical current is insufficient to operate the first spa device and the second spa device simultaneously.

In accordance with another supplemental embodiment, the present invention can be characterized as a spa control system with a user interface, the user interface comprising: a portable device comprising: a circuitry adapted to receive power from a remote source over a communication link; provide a signal to a remote processor over the communication link.

In accordance with a further supplemental embodiment, the present invention can be characterized as a spa control system with a spa water heater; a temperature sensor operative to provide a temperature amount data representing a temperature amount of the spa water heater when the spa water heater is inactive; a processor coupled to the temperature sensor, wherein the processor is adapted to receive the temperature amount data; determine the temperature amount data is equal to or below a predetermined temperature amount; and activate a spa device for a predetermined time period at a beginning of a heat on cycle when the processor determines the temperature amount data is at or below the predetermined temperature mount.

In accordance with yet an additional supplemental embodiment, the present invention can be characterized as a spa control system with a spa water heater; a temperature sensor operative to provide a temperature amount data representing a temperature amount of the spa water heater when the spa water heater is inactive; a processor coupled to the temperature sensor, wherein the processor is adapted to receive the temperature amount data; determine the temperature amount data is equal to or is below a predetermined temperature amount; provide a signal to a user interface representing the temperature amount data is equal to or is below a predetermined temperature amount; activate the spa device at the predetermined level; a user interface coupled to the processor, the user interface comprising: a display operative to provide data representing the temperature amount data is equal to or is below the predetermined temperature amount; and a user manipulatable trigger operative to provide a signal to the processor representing an activation of the spa device to operate at the predetermined level.

In accordance with yet a further additional embodiment, the present invention can be characterized as a spa control system with a temperature sensor operative to provide a temperature amount representing a temperature of a main body spa water; and a processor coupled to the temperature sensor, the processor adapted to deactivate a spa device when a spa water heater is inactive and the temperature amount equals and exceeds a preset spa temperature amount by a predetermined amount.

In accordance with yet another supplemental embodiment, the present invention can be characterized as a spa control system with a spa water heater; a temperature sensor operative to provide a temperature amount data, wherein the temperature amount data represents a temperature of the spa water heater; a processor coupled to the temperature sensor, wherein the processor is adapted to receive the temperature amount data for a continuous time period; detect a sharp increase of the temperature amount data during the continuous time period; and deactivate the spa water heater when the processor detects the sharp increase of the temperature amount data during the continuous time period In accordance with another further additional embodiment, the present invention can be characterized as a spa control system with a spa water heater, a temperature sensor operative to provide a temperature amount data, wherein the temperature amount data represents a temperature of the spa water heater, a processor coupled to the temperature sensor, wherein the processor is adapted to activate the spa water heater for a predetermined time amount during a beginning of a spa water heater on cycle; receive the temperature amount data for the predetermined time amount during the beginning of the spa water heater on cycle; and reactivate the spa water heater after the predetermined time amount when the temperature amount data during the predetermined time amount decreases after an initial increase.

In accordance with yet another embodiment, the present invention can be characterized as a spa control system with a spa water heater; a temperature sensor operative to provide a temperature amount data, wherein the temperature amount data represents a temperature of the spa water heater; a processor coupled to the temperature sensor, wherein the processor is adapted to activate the spa water heater at a first power level for a predetermined amount of time during a beginning of a spa water heater on cycle, receive the temperature amount data for the predetermined time amount during the beginning of the spa water heater on cycle; activate the spa water heater at a second power level after the predetermined time amount when the temperature amount data during the predetermined time amount decreases after an initial increase; and deactivate the spa water heater after the predetermined time amount when the temperature amount data during the predetermined time amount fails to decrease after an initial increase.

In accordance with another additional embodiment, the present invention can be characterized as a spa control system with a spa water heater, a temperature sensor operative to provide a temperature amount data of the spa water heater; a first electrical relay board coupled to the spa water heater, wherein the first electrical relay board is adapted to provide an electrical current amount to the spa water heater; a second electrical relay board coupled to the spa water heater, wherein the second electrical relay board is adapted to provide a second electrical current amount to the spa water heater; a processor coupled to the first electrical relay board and the second electrical relay board, wherein the processor is adapted to disable the second electrical relay board when a rate of change of the temperature amount data exceeds a predetermined rate of change of a temperature amount data.

In accordance with yet another additional embodiment, the present invention can be characterized as a spa control system with a spa water heater; a temperature sensor operative to provide a temperature amount data of the spa water heater; a software time clock operative to provide a signal activating the spa water heater based upon a predetermined time period; a processor coupled to the spa water heater, wherein the processor is adapted to disable the signal activating the spa water heater when the temperature amount data exceeds a preset main body spa water temperature amount.

In accordance with an additional embodiment, the present invention can be characterized as a spa control system with a spa water heater; a user interface, the user interface comprising: a plurality of user manipulatable triggers each operative to provide a signal indicating a user manipulation of a user manipulatable trigger; a processor coupled to the user interface and the spa water heater, wherein the processor is adapted to activate a spa water heater when the processor detects the signal indicating the user manipulation of a user manipulatable trigger.

In accordance with a another additional embodiment, the present invention can be characterized as a spa control system with a filtration pump, a temperature sensor operative to provide a temperature amount data representing a temperature amount of a surrounding environment when a spa water heater is inactive, a memory device operative to record the temperature amount data of the spa water heater for a predetermined time period; a processor coupled to the memory device and the filtration pump, wherein the processor is adapted to activate the filtration pump the next day at the same time period when a predetermined temperature amount data was recorded.

In accordance with yet another additional embodiment, the present invention can be characterized as a spa control system with a power line, adapted to provide a current to a control module; and a 240-VAC coiled single pole double throw relay coupled to the power line, wherein the 240-VAC coiled single pole double throw relay is operative to prevent a 120-VAC power connection. A spa control system, the spa control apparatus comprising: a control module, wherein the control module is adapted to be replaceable by a user.

In accordance with a supplemental embodiment, the present invention can be characterized as a spa control system with a temperature sensor housing, wherein the temperature sensor housing is adapted to be replaceable a user.

In accordance with another supplemental embodiment, the present invention can be characterized as a spa control system with an electrical circuit board, the electrical circuit board comprising: a receptacle mounted on the electrical circuit board, wherein the receptacle is adapted to provide an electrical current to an electrically connected spa device; a finger attached to the electrical circuit board, wherein the finger is adapted to receive an electrical current; an electrical relay board coupled to the electrical circuit board, the electrical relay board comprising: a slot, wherein the slot is adapted to engage the finger of the electrical circuit board and provide an electrical current; and a control circuit board coupled to the relay board wherein the control circuit board is adapted to provide an electrical current to the electrical relay board.

In accordance with a farther supplemental embodiment, the present invention can be characterized as a spa control system with a control unit a four wire serial data cable coupled to the control unit, wherein the four wire serial data cable is operative to provide a ground, a voltage for power, and a digital communication link; and an electrical relay board coupled to the four wire serial data cable.

The present invention further provides a method of mounting a spa control panel onto a spa surface, which comprises: drilling an opening on the spa surface; positioning a connective wire through the opening; attaching the connective wire to the spa control panel; mounting the control panel on top of the opening on the spa surface; and applying adhesive material between the spa surface and control panel.

In accordance with yet another embodiment, the present invention can be characterized as a spa control system with a blower; a temperature sensor operative to provide a temperature amount data representing a temperature amount of a main spa body water; a processor coupled to the blower and the temperature sensor, wherein the processor is adapted to activate the blower at predetermined time periods and when the temperature amount data exceeds a preset spa temperature amount.

There are additional aspects to the present inventions. It should therefore be understood that the preceding is merely a brief summary of some embodiments and aspects of the present inventions. Additional embodiments and aspects are referenced below. It should be further understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 illustrates a diagram of a system for controlling a spa (spa control system).

FIG. 2 illustrates a diagram of a variation of the spa control system, such as shown in FIG. 1, featuring a processor communicating with a user interface and a display;

FIG. 3 illustrates a diagram of one variation of the spa control system of FIG. 1 for providing a user an option to select from a menu of electrical current settings for a spa device;

FIG. 4 illustrates a diagram of a variation of the spa control system, such as shown in FIG. 1, featuring a spa control system utilizing an electrical current sensor for detecting available electrical current settings for spa device operation and providing a user a menu of the available electrical current settings;

FIG. 5 illustrates a diagram of a variation of the spa control system, such as shown in FIG. 1, featuring an electrical current sensor for regulating an electrical current flow to a spa device;

FIG. 6 illustrates a diagram of a variation of the spa control system, such as shown in FIG. 1, featuring an electrical current sensor for detecting a malfunction of a spa device;

FIG. 7 illustrates a diagram of a variation of the spa control system, such as shown in FIG. 1, featuring an electrical current sensor to provide information on a spa device;

FIG. 8 illustrates a diagram of a variation of the spa control system, such as shown in FIG. 1, featuring an electrical current sensor for detecting an electrical current overload;

FIG. 9 illustrates a diagram of a variation of the spa control system, such as shown in FIG. 1, featuring a temperature sensor for preventing an overheating of an electrical relay board;

FIG. 10 illustrates a diagram of a variation of the spa control system, such as shown in FIG. 1, featuring a temperature sensor for calculating spa water heater on cycles;

FIG. 11 illustrates a diagram of a variation of the spa control system, such as shown in FIG. 1, featuring a reprogrammable user manipulatable trigger of a user interface to control a 240-Volt circulation pump;

FIG. 12 illustrates a diagram of a variation of the spa control system, such as shown in FIG. 1, featuring a reprogrammable user manipulatable trigger of a user interface to control a spa device in 2 distinct levels of operation;

FIG. 13 illustrates a diagram of a variation of the spa control system, such as shown in FIG. 1, featuring a reprogrammable user manipulatable trigger of illustrates a diagram of a variation of the spa control system, such as shown in FIG. 1, featuring interface;

FIG. 14 illustrates a diagram of a variation of the spa control system, such as shown in FIG. 1, featuring a function for continuously incrementing or decrementing a spa temperature amount setting;

FIG. 15 illustrates a diagram of a variation of the spa control system, such as shown in FIG. 1, featuring a light energy powered portable device of a user interface;

FIG. 16 illustrates a diagram of a variation of the spa control system, such as shown in FIG. 1, featuring a plurality of control modules;

FIG. 17 illustrates a diagram of a variation of the spa control system, such as shown in FIG. 1, featuring a step-down transformer to transfer power to a control module;

FIG. 18 illustrates a diagram of a variation of the spa control system, such as shown in FIG. 1, featuring a plurality of processors to control a spa device and/or a sensor to maintain continuous operation of the spa device and/or sensor;

FIG. 19 illustrates a diagram of a variation of the spa control system, such as shown in FIG. 1, featuring two sensors in a single sensor housing to provide easier replacement of the sensors and to provide the sensors a self-checking mechanism;

FIG. 20 illustrates a diagram of a variation of the spa control system, such as shown in FIG. 1, featuring two sensors in a single sensor housing to provide easier replacement of the sensors and to provide the sensors a self-checking mechanism;

FIG. 211 illustrates a diagram of a variation of the spa control system, such as shown in FIG. 1, featuring the displaying of a temperature of the main body spa water based on a temperature data representing a temperature of a spa water heater over a continuous time period;

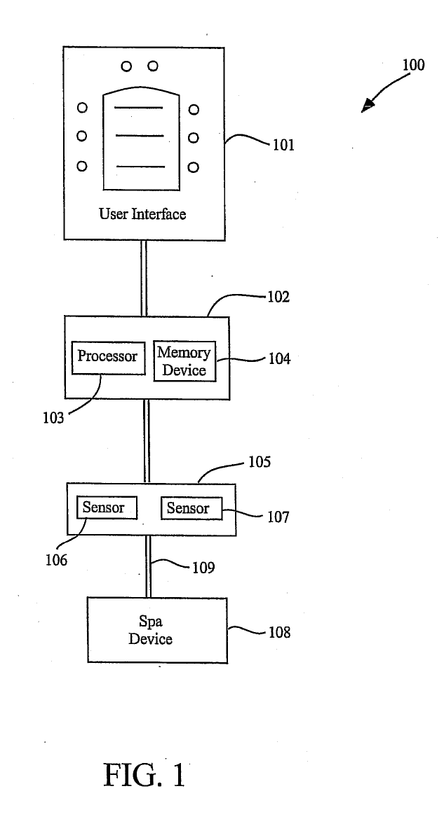

FIG. 22 illustrates a diagram of a variation of the spa control system, such as shown in FIG. 1, featuring a function to detect the presence of a first pump and activating a second pump when the first pump is not present or is not operational;

FIG. 23 illustrates a diagram of a variation of the spa control system, such as shown in FIG. 1, featuring the system reducing an operation level of a spa water heater when a spa lacks a power to operate a pump simultaneously;

FIG. 24 illustrates a diagram of a variation of the spa control system, such as shown in FIG. 1, featuring a portable device of a user interface that draws power from a remote control module through a communication link to control spa functions and/or devices;

FIG. 25 illustrates a diagram of a variation of the spa control system, such as shown in FIG. 1, featuring a temperature sensor and a processor to detect a freeze condition and activate a plurality of spa devices at the beginning of a spa water heater on cycle;

FIG. 26 illustrates a diagram of a variation of the spa control system, such as shown in FIG. 1, featuring the system providing a user an option to operate a pump at a low level when a freeze condition exists;

FIG. 27 illustrates a diagram of a variation of the spa control system, such as shown in FIG. 1, featuring the system disabling a pump when a spa water heater is inactive and a temperature of a main body spa water exceeds a set temperature amount;

FIG. 28 illustrates a diagram of a variation of the spa control system, such as shown in FIG. 1, featuring the system disabling a force filtration operation when a spa water heater is inactive and a temperature of a main spa body water is increasing;

FIG. 29 illustrates a diagram of a variation of the spa control system, such as shown in FIG. 1, featuring the system disabling a spa water heater when a processor detects a sharp increase in the spa water heater;

FIG. 30 illustrates a diagram of a variation of the spa control system, such as shown in FIG. 1, featuring the system disabling a spa water heater when a processor detects a sharp increase in the spa water heater;

FIG. 31 illustrates a diagram of a variation of the spa control system, such as shown in FIG. 1, featuring the system disabling a spa water heater when a processor detects an absence of a water in the spa water heater;

FIG. 32 illustrates a diagram of a variation of the spa control system, such as shown in FIG. 1, featuring the system activating a spa water heater at a first power level and then a second power level when a processor detects a presence of a water in the spa water heater;

FIG. 33 illustrates a diagram of a variation of the spa control system, such as shown in FIG. 1, featuring the system reducing a power level of a spa water heater when a temperature in the spa water heater increases excessively;

FIG. 34 illustrates a diagram of a variation of the spa control system, such as shown in FIG. 1, featuring the system activating a spa water heater based on a software time clock and a temperature amount of a spa water heater;

FIG. 35 illustrates a diagram of a variation of the spa control system, such as shown in FIG. 1, featuring the system activating a spa water heater based on a software time clock and a temperature amount of a spa water heater;

FIG. 36 illustrates a diagram of a variation of the spa control system, such as shown in FIG. 1, featuring the system activating a spa water heater based on actuating any available user manipulatable trigger of a user interface;

FIG. 37 illustrates a diagram of a variation of the spa control system, such as shown in FIG. 1, featuring the system activating a spa water heater based on actuating any available user manipulatable trigger of a user interface;

FIG. 38 illustrates a diagram of a variation of the spa control system, such as shown in FIG. 1, featuring the system using an ambient temperature to manage a temperature of a main body spa water;

FIG. 39 illustrates a diagram of a variation of the spa control system, such as shown in FIG. 1, featuring the system cooling a main body spa water using an ambient air and a blower;

FIG. 40 illustrates a diagram of a variation of the spa control system, such as shown in FIG. 1, featuring the system detecting a correct power connection to a spa;

FIG. 41 illustrates a diagram of a variation of the spa control system, such as shown in FIG. 1, featuring the system permitting a user to replace a control module or a temperature sensor housing;

FIG. 42 illustrates a diagram of a variation of the spa control system, such as shown in FIG. 1, featuring the system reducing an amount of conductive wires by using a slotted electrical relay board and a fingered electrical circuit board;

FIG. 43 illustrates a diagram of a variation of the spa control system, such as shown in FIG. 1, featuring a control unit connecting to a spa device and/or sensor with a 4 wired serial data cable;

FIG. 44 illustrates an exemplary process of mounting a spa control panel onto a spa surface; and

FIG. 45 illustrates a diagram of a variation of the spa control system, such as shown in FIG. 1, featuring a keyed mount for a spa water heater.

### DETAILED DESCRIPTION

The following is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention. It is also understood that the following embodiments, and their equivalents, may be combined in various combinations.

Referring to FIG. 1, there is shown an exemplary spa control system 100 comprising a plurality of devices that can be used to control various spa operations. The spa control system in FIG. 1 comprises a control panel 101 that serves as a user interface for a spa control system, a control unit 102 comprising a processor 103 and a memory device 104, a sensor housing 107 comprising a high limit temperature sensor 105 and a temperature sensor 106, and a spa device 108. The plurality of devices are connected by conductive material 109 that can transmit both electrical current and signals representing data of various spa operations and functions.

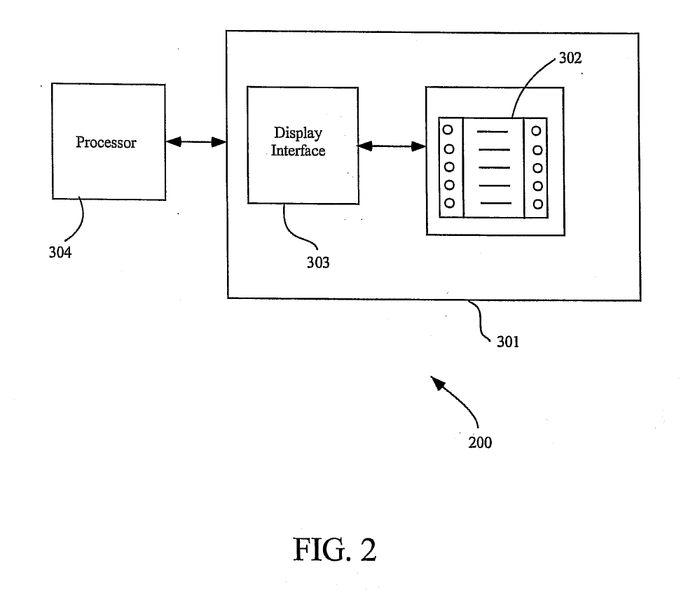

Referring to FIG. 2, there is shown a spa control system 200 for providing user perceptible data representing a spa operation on a display 302, where the display 302 may be of a variety of display technologies. Exemplary display technologies are plasma display, liquid crystal display, light emitting diode display. In alternative embodiments, however, other types and designs of display technologies may be used as well. Shown is a user interface 301 that comprises the display 302 and a display interface 303, and a processor 304.

The processor 304 is coupled to the display interface 303, the display interface 303 is coupled to the display 302. The processor 304 is adapted to provide signals representing spa operation to the user interface 301. Utilizing the display interface 303, adapted to function with the display 302 (i.e. a given particular type display), enables the user interface 301 to employ any type of display technology to provide user perceptible data, without having to change the processor 304 (by adapting the processor 304 or type of processor to the particular type of display technology). The display interface 303 is an exemplary means for the user interface 301 to convert signals representing a spa operation to a signal that the display 302 can convert to user perceptible data.

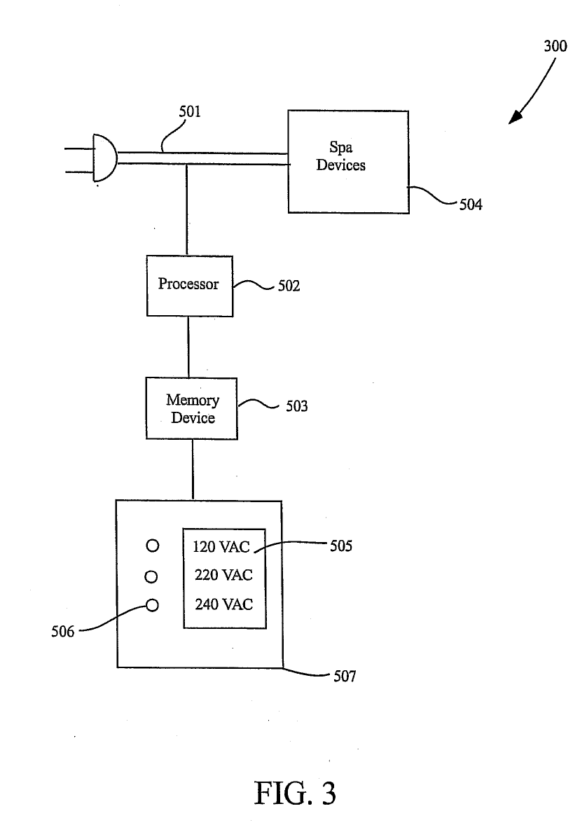

Referring to FIG. 3, there is shown a spa control system 300 for providing a user an electrical current amount with which to select and operate a spa. Shown is an incoming power line 501, a processor 502, a memory device 503, a spa device 504, and a user interface 507 comprising a display operative to provide an electrical current amount, a user manipulatable trigger 506, and a user interface 507.

The processor 502 is coupled to the incoming power line 501. The processor 502 is also coupled to the incoming power line 501. The memory device 503 is coupled to the processor 502, and the user interface 507 is coupled to the memory device 503. While the embodiment of FIG. 3 employs the processor 502 and the memory device 503, the use of the processor 502 and the memory device 503 are optional.

The display 505 of the user interface 507 is adapted to display to a user at least one electrical current amount to select for a spa operation. In operation, the user selects the current amount by manipulating a user manipulatable trigger 506 (such as a button). The user manipulatable trigger 506 is adapted to provide a signal indicating the electrical current amount that the user has selected. The processor 502 or a mechanism that is capable of detecting the electrical current amount selected may be employed to detect the electrical current amount selected and to monitor an amount of electrical current that is flowing to the components within the spa device 504. Because the user is able to select such amount of current, the system provides greater control over the operation of the spa as described in further detail elsewhere herein.

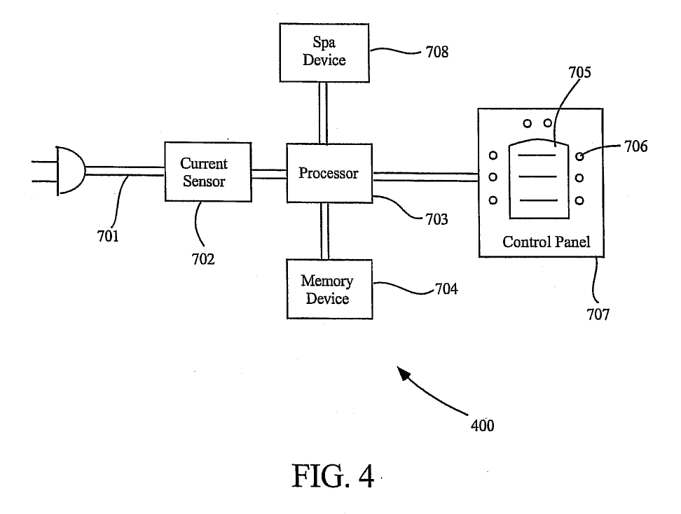

Referring to FIG. 4, there is shown a spa control system 400 for providing a user an available electrical current amount to select. Shown is an incoming power line 701, a spa device 708, an electrical current sensor 702, a processor 703, a memory device 704, and a user interface 707 comprising a display 705 displaying the available electrical current amount data, and a user manipulatable trigger 706. The electrical current sensor 702 is coupled to the incoming power line 701, the processor 703 is coupled to the electrical current sensor 702, the memory device 704 is coupled to the processor 703, the user interface 707 is coupled to the processor 703. While the embodiment of FIG. 4 employs a memory device 704, the use of the memory device 704 is optional.

A current sensor 702, such as a torrid, is coupled to the incoming power line 701 that provides electrical current to the spa device 708. The electrical current sensor 702 is adapted to determine an amount of electrical current, representing an amount of electrical current flow through the incoming power line 701 and provide an electrical current amount signal indicative of the electrical current amount to the user interface 707.

The display 705 of the user interface 707 is adapted to display (such as by visual display, audible display (e.g. voice or the like)) at least one electrical current amount. The user selects the electrical current amount, as displayed by the display 705, by manipulating a user a manipulatable trigger 706, preferably, a plurality of electrical current amounts are displayed, and the user manipulatable trigger 706 allows selection of the electrical current amount from amongst this plurality of electrical current amount. The user manipulatable trigger 706, which may be a touch screen, a button, or voice recognition and the like, is adapted to provide a signal indicating the electrical current amount that the user has selected to operate the spa. The processor 703 or another mechanism that is capable of selecting the electrical current amount is employed to manipulate the electrical current amount that is providing power to the spa device 708. This system provides greater control over the operation of the spa.

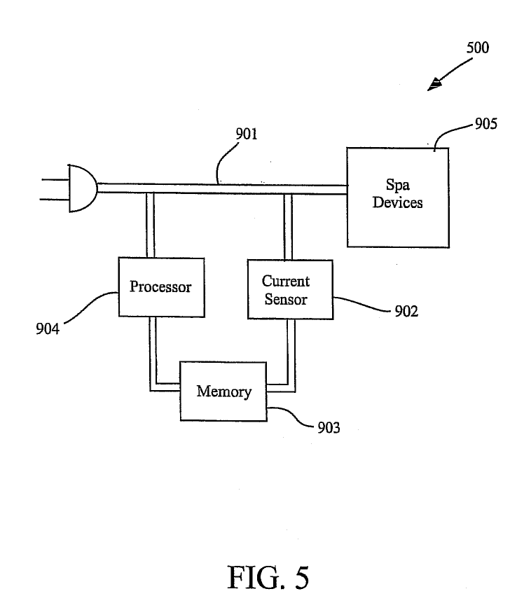

Referring to FIG. 5, there is shown a spa control system 900 for regulating electrical current flow to a spa device. Shown is an incoming power line 901, an electrical current sensor 902, a memory device 903, a processor 904, and a spa device 905. The processor 904 is coupled to the incoming power line 901, the electrical current sensor 902 is also coupled to the incoming power line 901, the memory device 903 is coupled to the processor 904 and the electrical current sensor 902, and the spa device 905 is coupled to the incoming power line 901.

The electrical current sensor 902 is adapted to provide a measured electrical current amount (via a measured electrical current amount signal). The measured electrical current amount is stored in the memory device 903. The processor 904 is adapted to compare the measured electrical current amount stored in the memory device 903 with a target electrical current amount, also stored in a memory device 903, for a proper operation of the spa device 905. If the target electrical current amount in the memory device 903 and the measured electrical current amount, as indicated by the measured electrical current amount signal are not equal, the processor 904 provides a signal indicating that the measured electrical current amount is not the electrical current amount for the proper operation of the spa device (i.e., the target electrical current amount stored in the memory device 903). Upon receiving the signal indicating that the electrical current amount as indicated by the electrical current amount signal is not the electrical current amount for the proper operation of the spa device 905, the processor 904 or another mechanism that is capable of regulating electrical current flow, may be employed to adjust the electrical current flow to a current amount that enables a proper operation of the spa device 905. This system provides a self-correcting mechanism for proper spa operation.

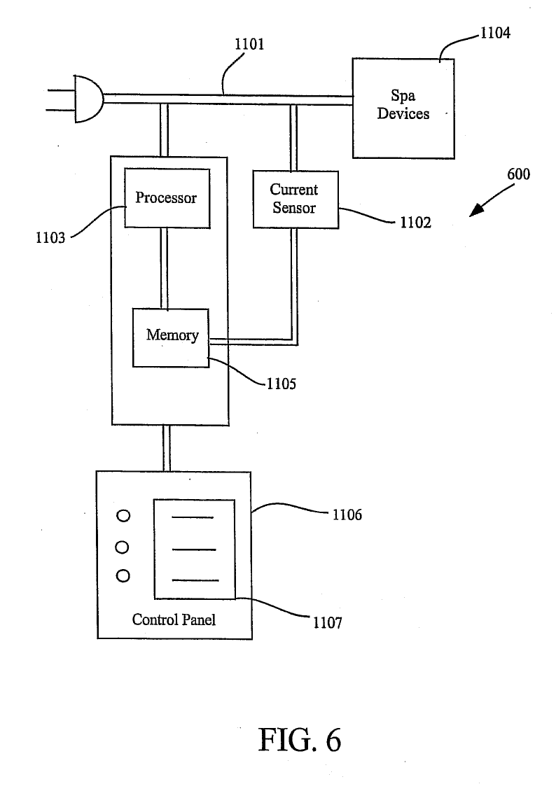

Referring to FIG. 6, there is shown a spa control system 600 for detecting and indicating a spa device malfunction. Shown is an incoming power line 1101, an electrical current sensor 1102, a processor 1103, a spa device 1104, a memory device 1105, and a user interface 1106 comprising a display 1107. The processor 1103 is coupled to the incoming power line 1101. The electrical current sensor 1102 is also coupled to the incoming power line 1101. The memory device 1105 is coupled to the processor 1103 and the electrical current sensor 1102. The spa device 1104 is coupled to the incoming power line 1101, and the user interface is coupled to the processor 1103.

The electrical current sensor 1102 is adapted to generate a measured electrical current amount signal indicative of the measured current amount. The measured electrical current amount is stored in the memory device 1105. The processor 1103 is adapted to compare the measured electrical current amount in the memory device 1105 with a target electrical current amount for a proper operation of the spa device 1104. The target electrical current amount is also preferably stored in the memory device 1105. If the current amounts are not equal, or within a specified tolerance of one another, the processor 1103 provides a signal indicating that the measured electrical current amount data is not the target electrical current amount for the proper operation of the spa device 1104. Upon receiving the signal indicating that the measured electrical current amount is not the target electrical current amount for the proper operation of the spa device or not within a specified tolerance or such, the processor 1103 and/or a circuitry that is capable of disabling the spa device 1104 will disable the spa device 1104. The processor 1103 may then provide a signal to the user interface 1106 indicating a device malfunction. The user interface 1106 may in turn be adapted to provide a data representing the measured electrical current amount is not the target electrical current amount for the proper operation of the spa device 1104, such as by displaying a blinking light.

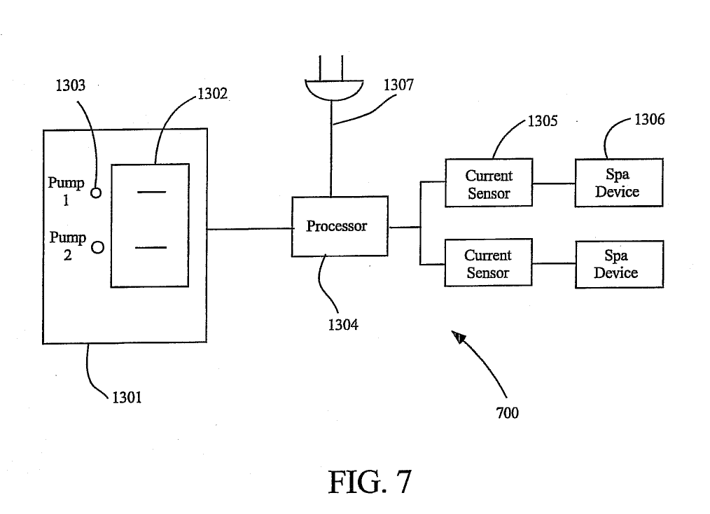

Referring to FIG. 7, there is shown a spa control system 700 utilizing an electrical current sensor 1305 to provide information on a spa device 1306 and provide a user various options to operate the spa device 1306 based on the information provided by the electrical current sensor 1305. Shown is a user interface 1301 comprising a display 1302 and a user manipulatable trigger 1303, a processor 1304, the electrical current sensor 1305, the spa device 1306, and an incoming power line 1307.

The electrical current sensor 1305 is coupled to the spa device 1306 and the incoming power line 1307 through the processor 1304, which is coupled to the electrical current sensor 1305 and the user interface 130l, the incoming power line 1307 is coupled to the processor 1304.

The electrical current sensor 1305 is adapted to provide to a processor 1304 a measured electrical current amount signal indicating measured electrical current amount based on a measured electrical current that is flowing through the incoming power line 1307 to the spa device 1306. In one embodiment, a processor 1304 is adapted to determine that a spa device 1306 is operating based on the measured electrical current amount and an electrical current amount that the spa device is manufactured to draw. The processor 1304 is further adapted to generate a signal to the user interface 1301 representing the spa device 1306 is operating.

In another embodiment a processor 1304 is adapted via software or firmware, to compute an available operating level (speed setting amount) available for the spa device 1306 (for example, if the electrical current amount data is less than 16.7 amps then it must be a 120 VAC device; if the electrical current amount data is between 16.7 amp and 25 amps then it must be a 240 VAC device—based on a VAC amount the processor will provide a corresponding available operating level amount (speed setting) to a display of the user interface: 20 amps for a 120 VAC device; 30 or 50 amps for a 240 VAC device). A user can select the operating level amount through a user manipulatable trigger 1303 that corresponds with the operating level (speed setting) and the user manipulatable trigger 1303 will send a signal to the processor 1304 representing the operating level amount.

In yet another embodiment, a processor is adapted to determine whether a heat device is operating based on the measured electrical current amount and a target electrical current amount corresponding to an amount of current a heat device is manufactured to draw. The processor 1304 is further adapted to provide a signal to the user interface 1301 representing the heat device is operating, and the user interface 1301 is adapted to display the heat device as pump one, even if the heat device is not connected to pump one, thereby enabling a user to always control the heater device through the user manipulatable trigger associated with pump one 1303.

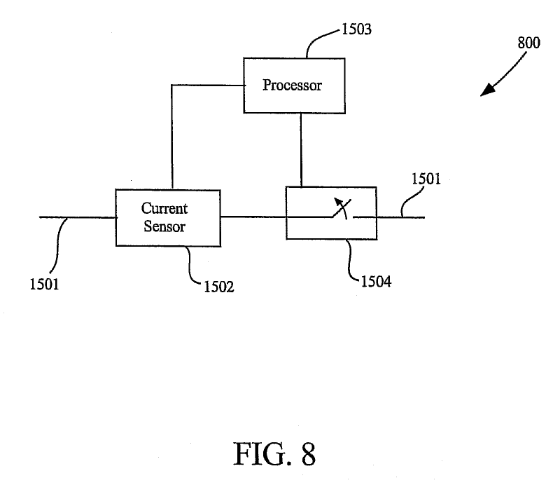

Referring to FIG. 8, there is shown a spa control system 800 utilizing an electrical current sensor 1502 to determine if there is an electrical current overload. Shown is a control contact 1501, an electrical current sensor 1502, a processor 1503, and a control contact switch 1504. The electrical current sensor 1502 is coupled to the control contact 1501, a processor 1503 is coupled to the current sensor 1502 and the control contact switch 1504.

The electrical current sensor 1502 is used to provide a measured electrical current amount data representing the measured electrical current amount through a printed circuit board which may be separate from a control circuit board, the processor 1503 is adapted to determine if the measured electrical current amount is a correct amount, or within a tolerance of the correct amount, for a proper spa device operation. If the measured electrical current amount is the correct amount for the proper spa device operation the processor 1503 will provide a signal indicating the measured electrical current amount data is the correct amount for the proper spa device operation and close the control contact switch 1504 to allow an electrical current to flow. However, if the measured electrical current amount is not the correct amount for a proper spa device operation the processor will provide a signal indicating the measured electrical current amount is not the correct amount for the proper spa device operation and open the control contact switch 1504 to prevent an overload situation from occurring. This system provides an alternative to utilizing a fuse.

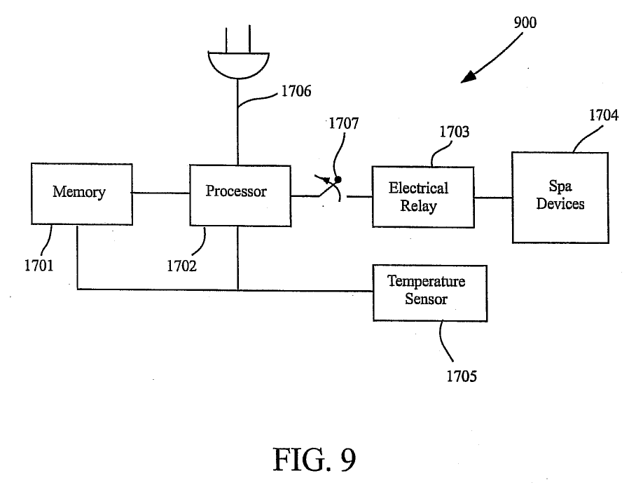

Referring to FIG. 9, there is shown a spa control system 900 utilizing a temperature sensor 1705 for preventing an overheating of an electrical relay board 1703. Shown is a memory device 1701, a processor 1702, an electrical relay board 1703, a spa device 1704, a temperature sensor 1705, an incoming power line 1706, and a circuit switch 1707. The memory device 1701 is coupled to processor 1702, the processor is coupled to the circuit switch 1707 and the incoming power line 1706, the electrical relay board 1703 is coupled to the circuit switch 1707, the spa device 1704 is coupled to the electrical relay board 173, and the temperature sensor 1705 is coupled to the processor 1702 and the memory device 1701.

The temperature sensor 1705 is placed near the electrical relay board 1703 to provide a temperature amount signal representing the temperature of the electrical relay board 1703. The processor 1702 is adapted to detect when the temperature amount is not an amount for a proper electrical relay board 1703 operation and in one embodiment the processor will provide a signal to open the voltage switch 1707 thereby cutting all current flow to the electrical relay board 1703 and the spa device 1704 attached to the electrical relay board 1703, in the event the temperature amount is not an amount, or within a tolerance of the amount for proper electrical operation.

In another embodiment, the processor 1702 can be further adapted to store the temperature amount to the memory device 1701 for repair reference. In yet another embodiment, a user interface is adapted to display data indicating the temperature amount data is not an amount for a proper electrical relay board 1703 operation. This processor 1702 can be further adapted to require that the electrical relay board 1703 be replaced and temperature information in the memory device 1701 reset before the processor 1702 will close the switch 1707.

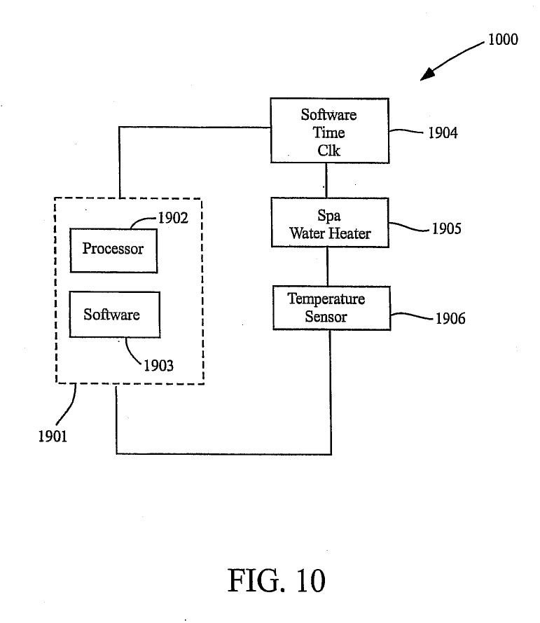

Referring to FIG. 10, there is shown a spa control system 1000 utilizing a temperature sensor 1906 for calculating and manipulating spa water heater on cycles. Shown is a control unit 1901, a processor 1902, a software 1903, a software time clock 1904, a spa water heater 1905, and a temperature sensor 1906. The control unit 1901 is comprised of a processor 1902 and a software 1903 adapted to calculate amount of heat loss in the spa water heater during each heat/cool cycle. The control unit 1901 is coupled to the software time clock 1904, the software time clock 1904 is coupled to the spa water heater 1905, and the temperature sensor 1906 is coupled to the control unit 1901.

The processor 1902 is adapted via software to compute a time to begin a heat cycle and/or end a heat cycle based on a temperature amount data provided by the temperature sensor 1906 and a desired temperature amount set by a user. The minimum heat cycle off time is two hours while the minimum heat cycle on time is fifteen minutes. This system 1000 maintains an automatic activation of the spa water heater but makes adjustments to the length of each cycle based on the measured temperature amount of the spa water heater.

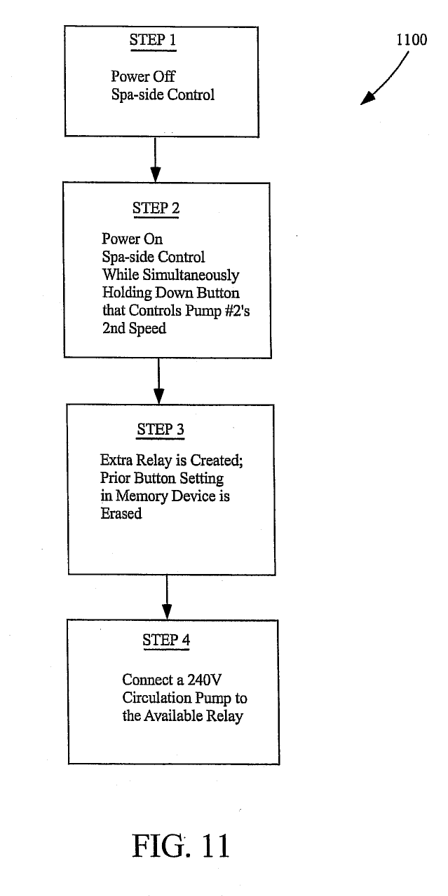

Referring to FIG. 11, there is shown a spa control system 1100 where a user can reprogram a functionality of a user manipulatable trigger of a user interface. FIG. 11 illustrates an exemplary spa control system reprogramming sequence whereby a user manipulatable trigger of a user interface that is programmed to control a second pump's second speed is reprogrammed to control a 240-Volt circulation pump instead. A processor is adapted to create an extra electrical relay board and reprogram the user manipulatable trigger representing an activation of a second pump's second speed to control a 240-volt circulation pump that is connected to the extra electrical relay board instead upon a simultaneous activation of a user manipulatable trigger representing activation of the spa control system and a user manipulatable trigger representing a second pump's second speed.

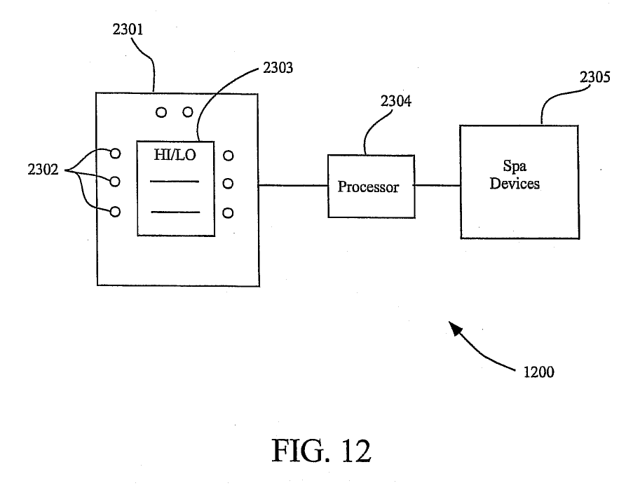

Referring to FIG. 12, there is shown a spa control system 1200for reprogramming a user manipulatable trigger 2302 of a user interface 2301. Shown is a user interface 2301, a plurality of user manipulatable triggers 2302, a display 2303, a processor 2304, and a spa device 2305. The user interface is coupled to the processor 2304, the processor 2304 is coupled to the spa device 2305 and the user interface 2301.

The processor 2304 and the user manipulatable triggers 2302 are adapted to control a particular spa device 2305 and/or a spa device level of operation 2303 based upon a particular sequence of activation of the user manipulatable triggers 2302. Another exemplary spa control system reprogramming is where a user manipulatable trigger 2302 of a user interface 2301 that is programmed to control a spa device 2305 can be reprogrammed to control the spa device in 2 distinct speeds based upon a particular sequence of activation of the user manipulatable triggers that the processor has been adapted to recognize.

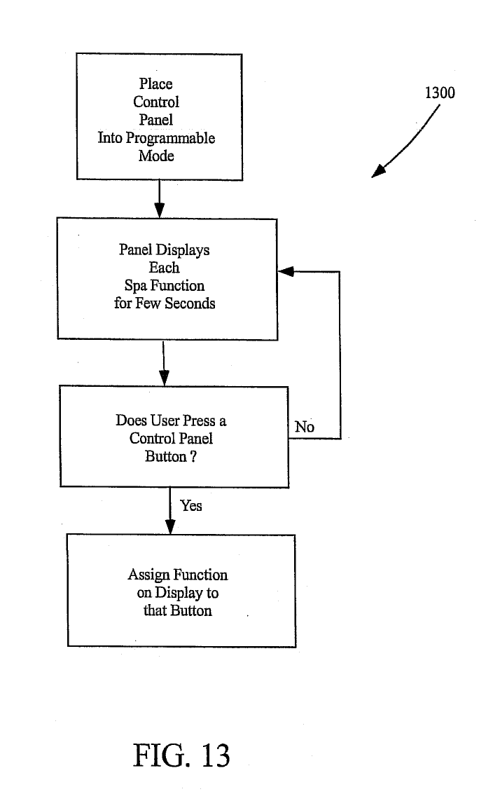

Referring to FIG. 13, there is shown a spa control system 1300 sequence for reprogramming a user manipulatable trigger of a user interface. A processor coupled to the user interface is adapted to be able to place a user interface into a programmable mode, to display on a user interface display a particular spa function for a specified time period, to assign a user manipulatable trigger to the particular spa function when the user manipulatable trigger is activated when the spa function is displayed on the user interface display.

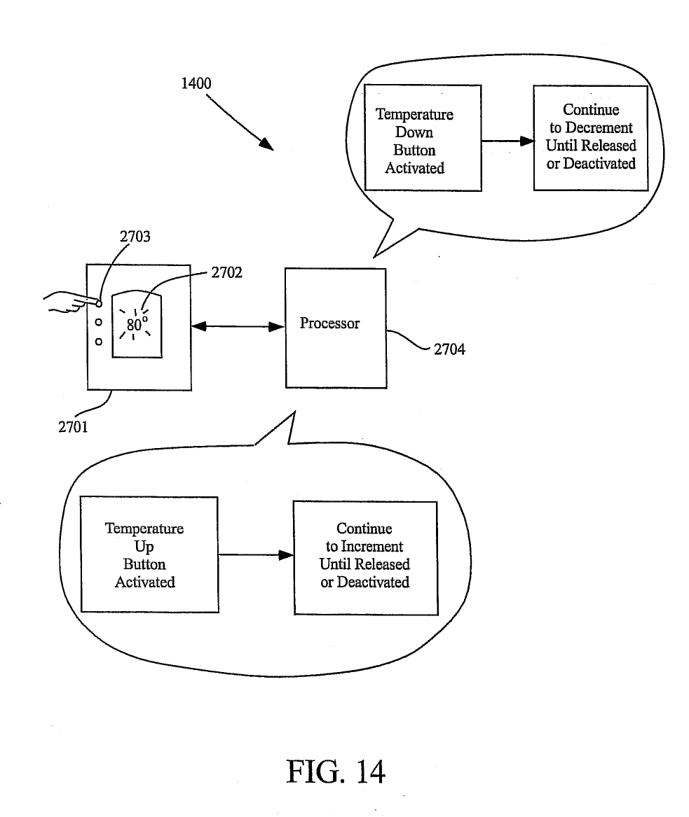

Referring to FIG. 14, there is shown a spa control system 1400 whereby a processor 2704 is adapted receive a continuous signal representing a continuous manipulation of a user manipulatable trigger 2703 to adjust a temperature amount for a spa operation, to increment or decrement a temperature amount data that is displayed on a user interface display 2702 when a user manipulatable trigger 2703 is activated or depressed without deactivating or releasing the user manipulatable trigger 2703. Shown is a user interface 2701, a display of a user interface 2702, a user manipulatable trigger 2703, and a processor. The user interface 2701 is coupled to the processor 2704.

In the illustrated embodiment, the user manipulatable trigger 2703 provides a continuous signal indicating a continuous user manipulation of the user manipulatable trigger 2703, the processor 2704 continuously increments or continuously decrements a temperature a user interface display 2702 operative to provide a data representing a temperature amount for a spa operation

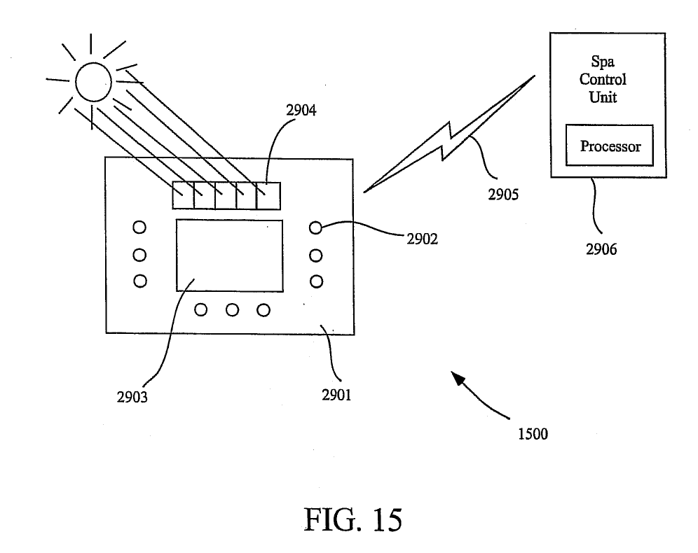

Referring to FIG. 15, there is shown a spa control system 1500 for utilizing light energy to power a portable device 2901 of a user interface. Shown is a portable user interface 2901, a user manipulatable trigger 2902, a display 2903, a panel adapted to receive light energy 2904, a processor within the portable device (not shown in FIG. 15) transmitting and receiving data over a communication link 2905, and a remotely located processor 2906.

The portable device 2901 of a user interface contains a power source enclosed within the housing that is adapted to generate power to the portable device 2901 with light energy that the power source receives through the panel 2904 that is adapted to receive light energy. Furthermore, the illustrated portable device 2901 of a user interface transmits a signal indicating a user manipulation of a user manipulatable trigger 2902 to a remotely located processor 2906 and receives and displays data 2903 representing a signal from the remotely located processor over a communication link 2905.

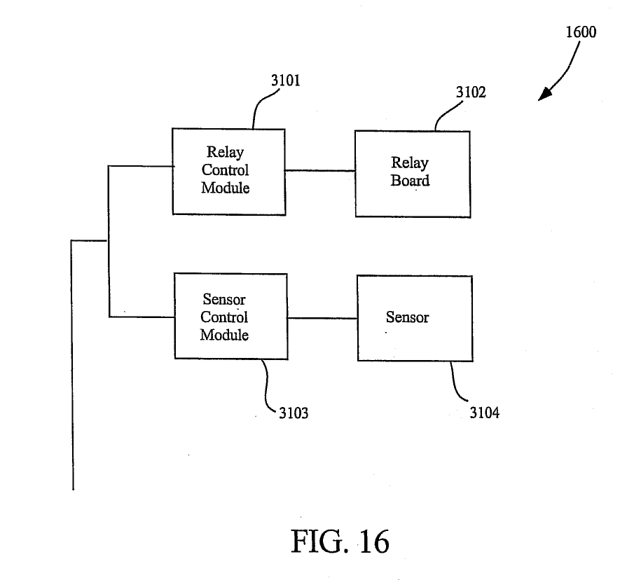

Referring to FIG. 16, there is shown a spa control system 1600 utilizing a modular approach to designing a control system. Shown is an electrical relay board control module 3101, an electrical relay board 3102, a sensor module 3103, and a sensor 3104. The electrical relay board control module 3101 is coupled to the electrical relay board 3102, the sensor module 3103 is coupled to the sensor 3104.

The illustrated spa control system utilizes separate control modules 3103 and 3104 for distinct spa devices 3102 and 3104. The modular approach permits replacing only a unit that has malfunctioned, therefore creates a cost effective way to repair the control system.

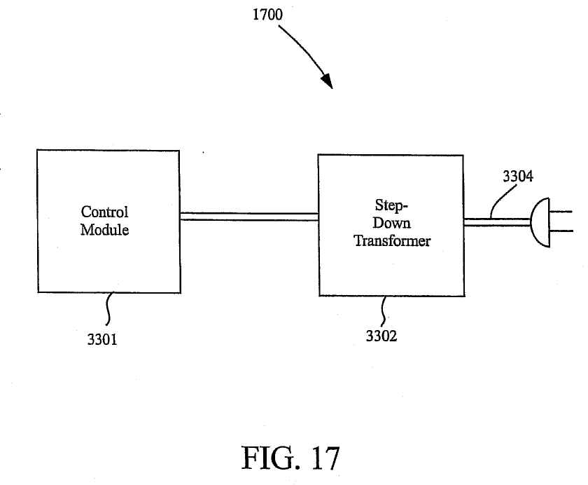

Referring to FIG. 17, there is shown a spa control system 1700 utilizing a step-down transformer 3302 thereby eliminating the need for conformal coating. Shown is a control module 3301, a step-down transformer 3302, and a incoming power line 3304. The control module 3301 is coupled to the step-down transformer 3302, the step-down transformer is coupled to the incoming power line 3304. To eliminate the need for conformal coating, the illustrated embodiment of the invention utilizes a step-down transformer 3302 to directly power the control module 3301.

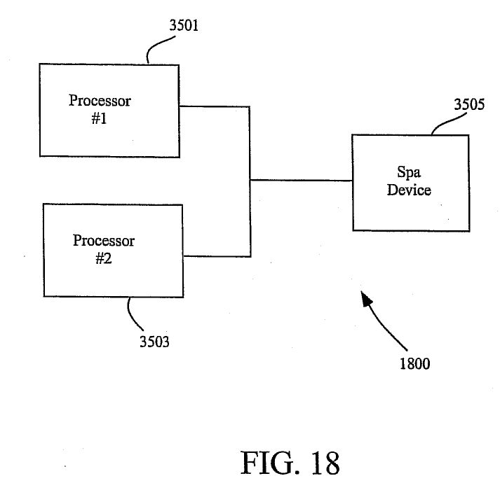

Referring to FIG. 18, there is shown a spa control system 1800 utilizing redundant processors 3501, 3503 to control a single spa device 3305. Shown is a first processor 3501, a second processor 3503, and a spa device 3505. The first processor 3501 is coupled to the spa device 3505. The second processor 3503 is also coupled to the spa device 3505. In the illustrated embodiment, the first processor and the second processor operates simultaneously to control the spa device 3505. In the event of a failure of one of the processors 3501, 3503 the spa device can continue to operate under the control of a single processor, or the spa device 3505 may be disabled until both processors 3501, 3503 are functional. In another embodiment the second processor 3503 can be adapted to activate only when the second processor 3503 detects a failure of the first processor 3501.

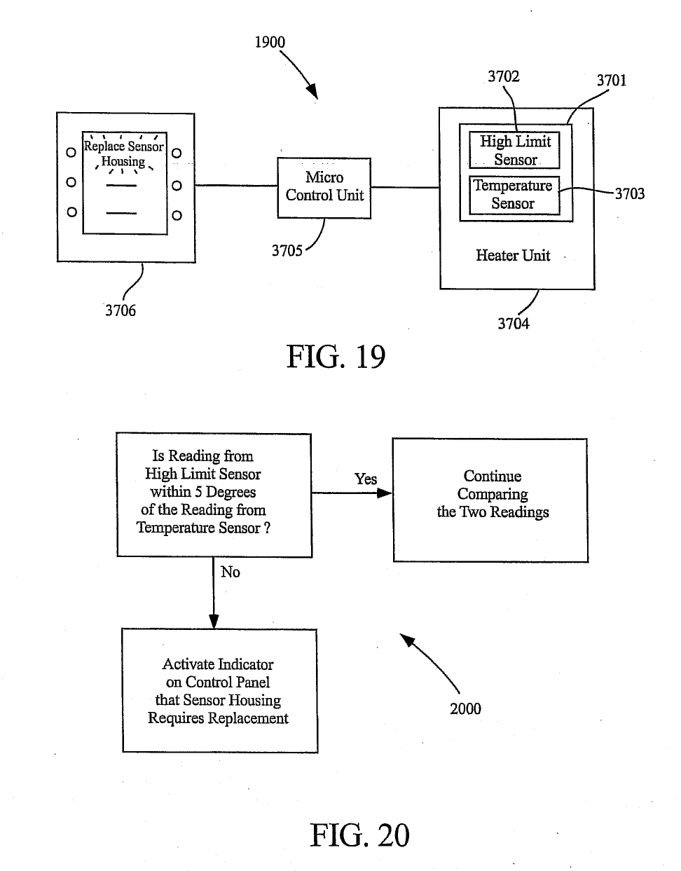

Referring to FIG. 19, there is shown a spa control system 1900 utilizing two temperature sensors in a single sensor housing 3701. Shown is a sensor housing unit 3701, a high limit sensor 3702, a temperature sensor 3703, a spa water heater device 3704, a processor 3705, and a user interface 3706. The high limit sensor 3702 and the temperature sensor 3703 are both contained in a sensor housing 3701. The sensor housing 3701 is placed in or adjacent to the spa water heater device 3704. The sensor housing 3701 is coupled to the processor 3705. The processor 3705 is connected to the user interface 3706.

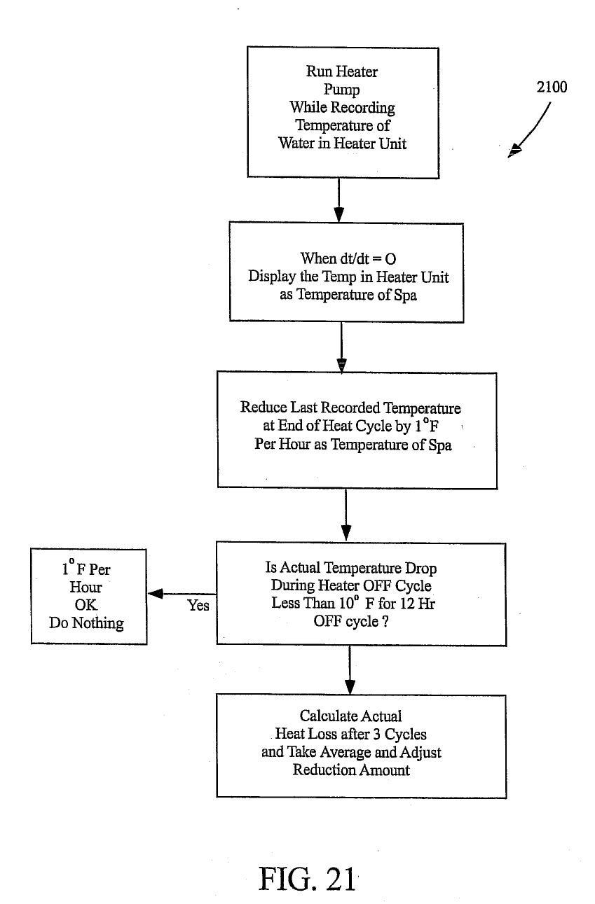

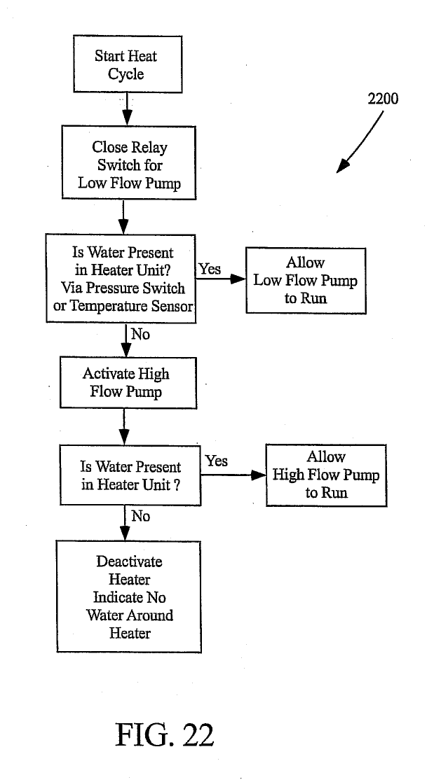

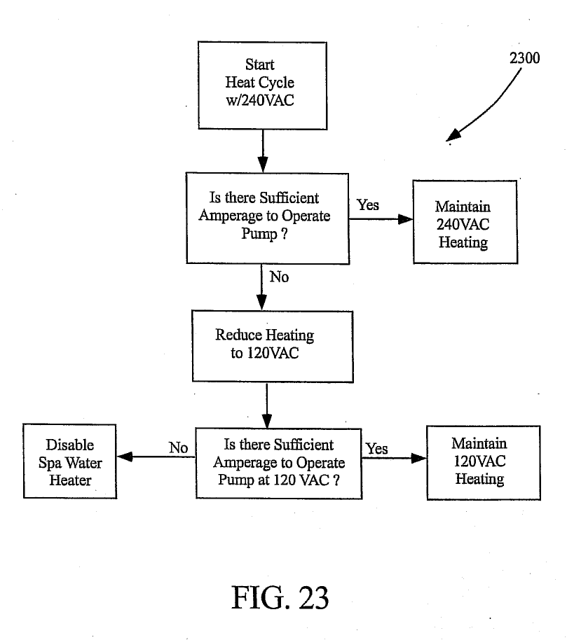

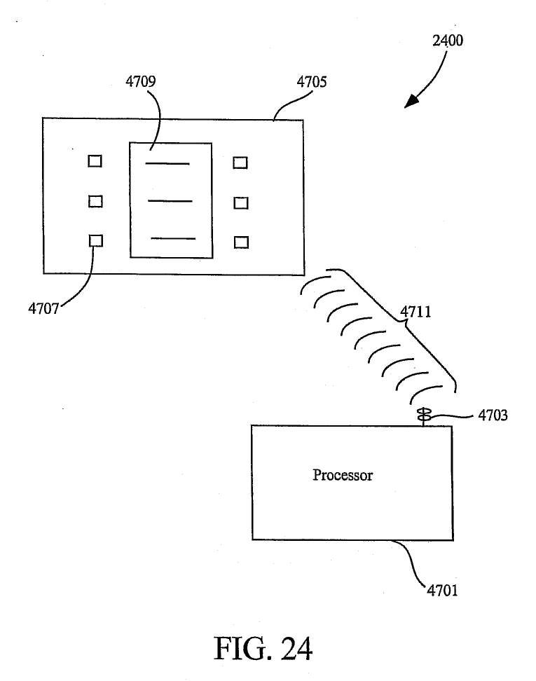

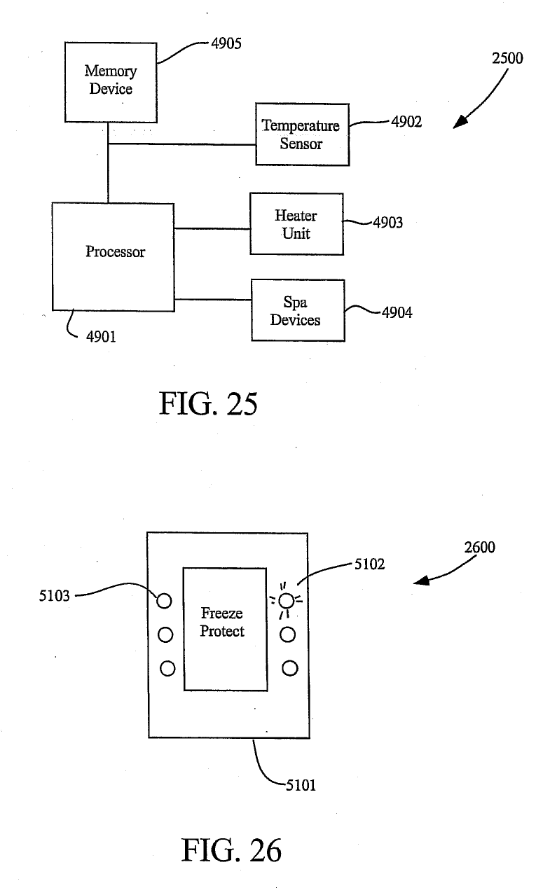

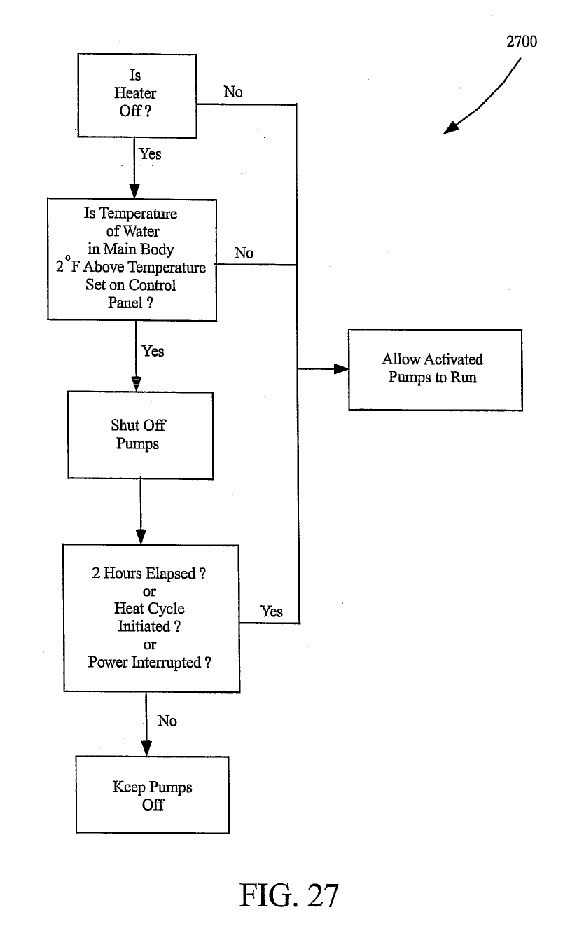

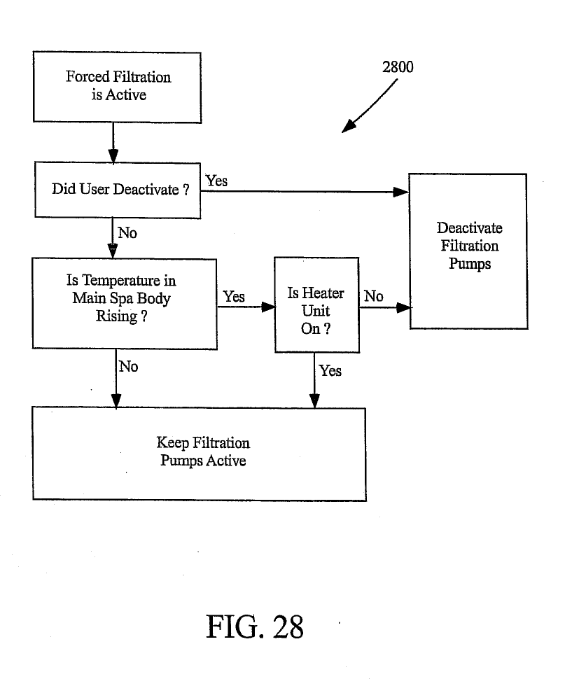

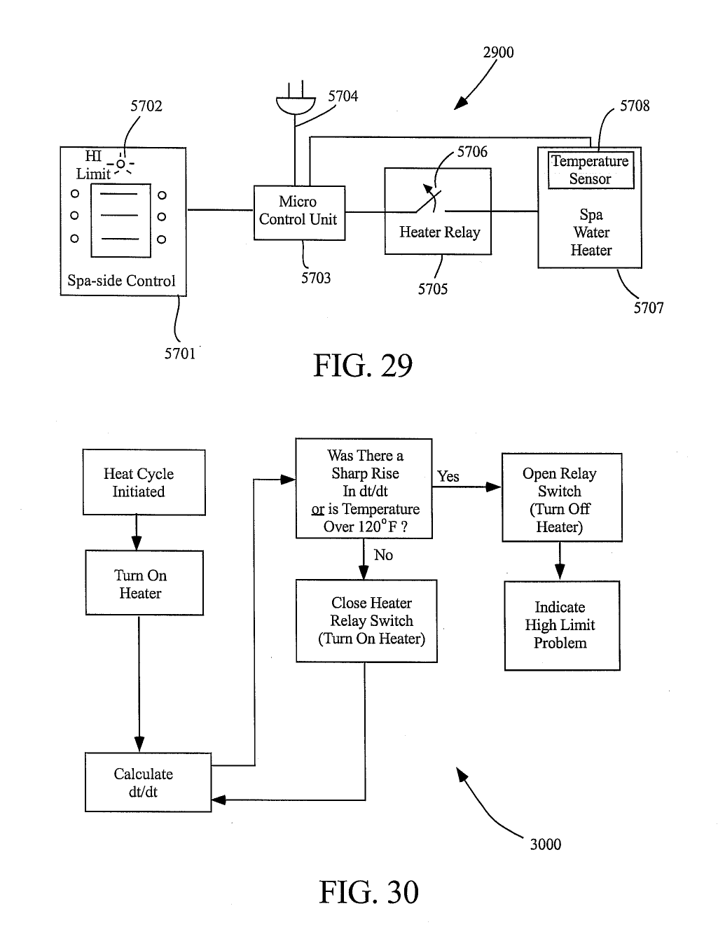

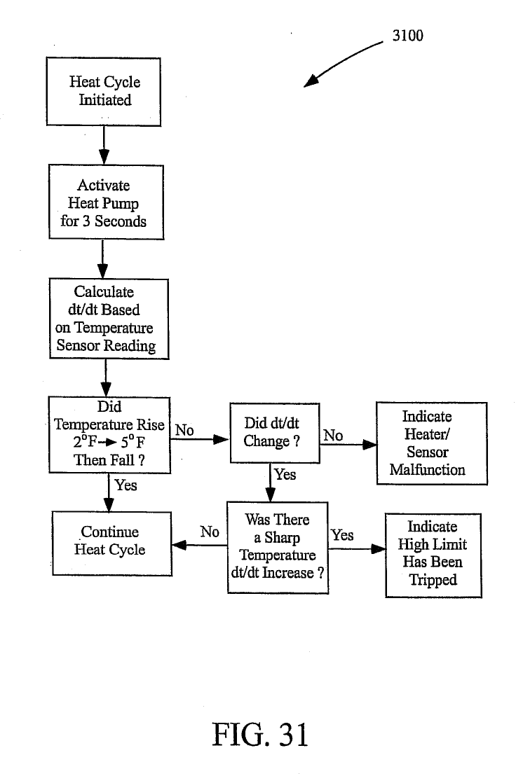

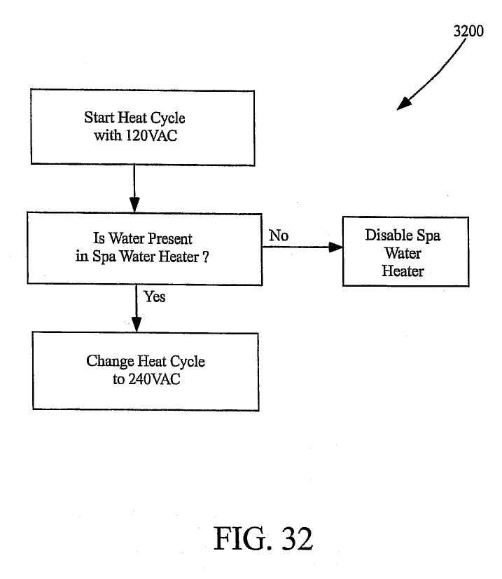

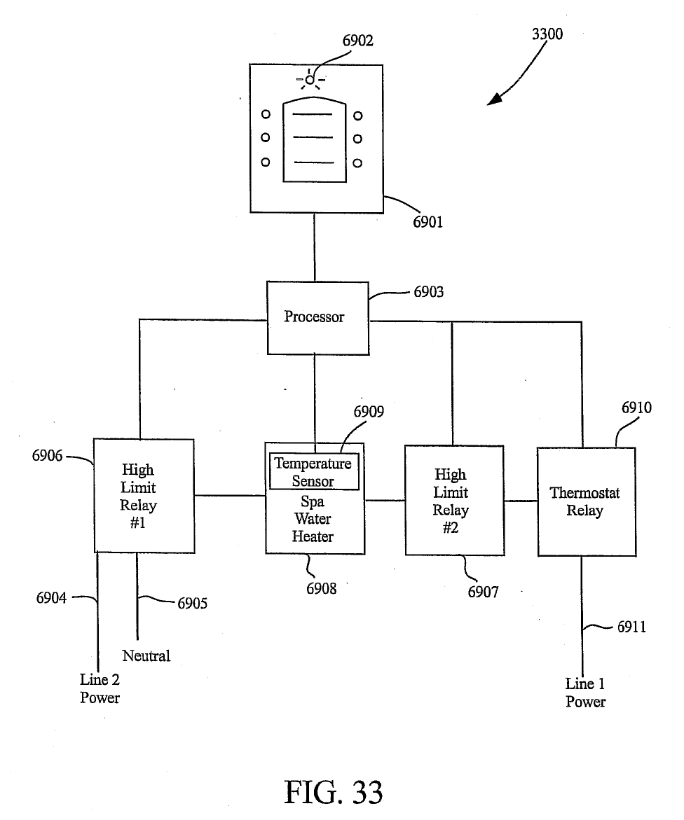

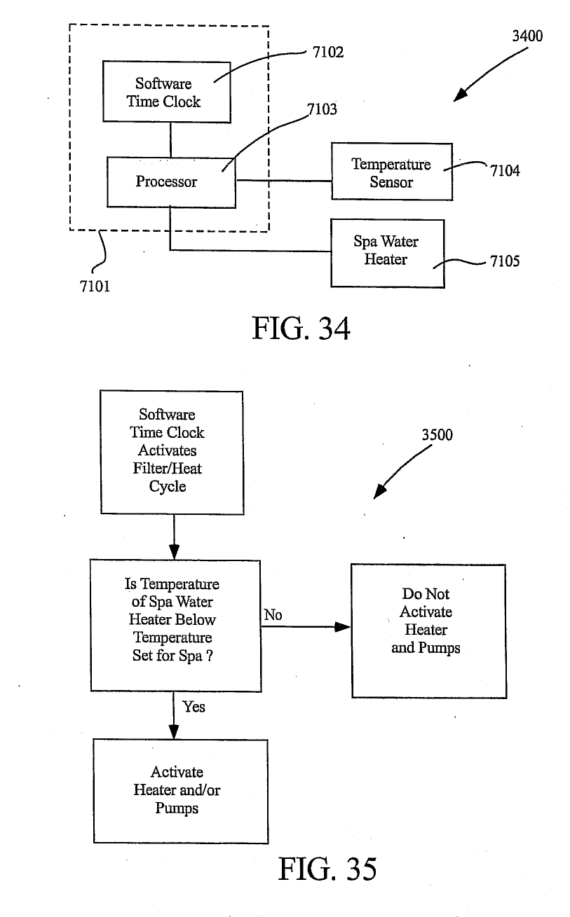

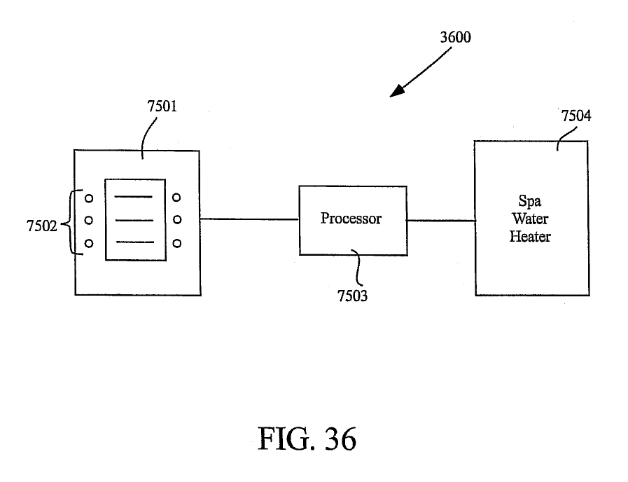

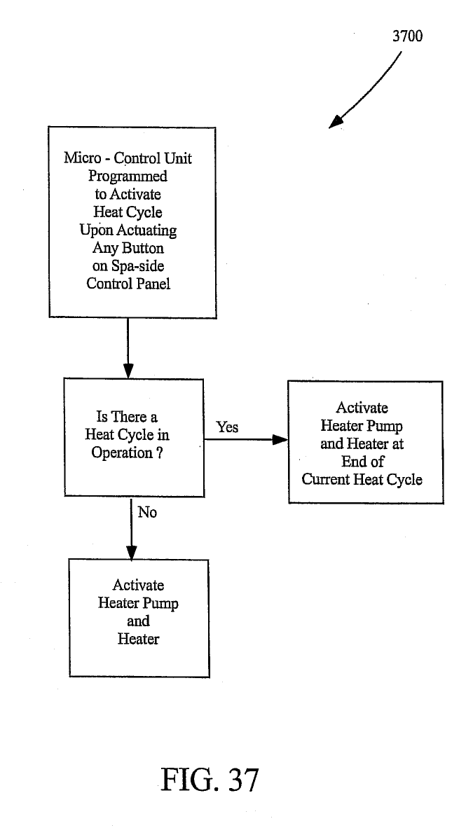

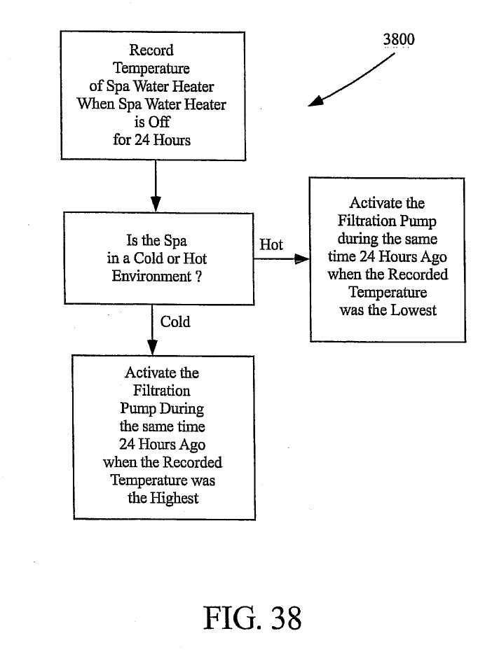

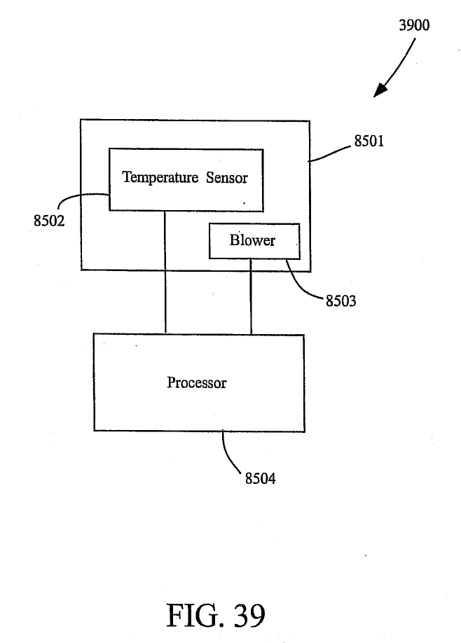

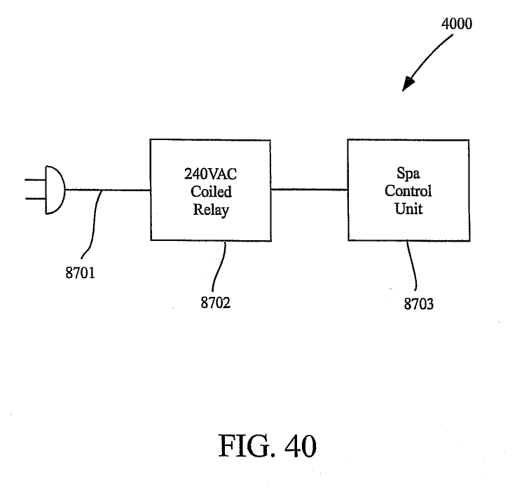

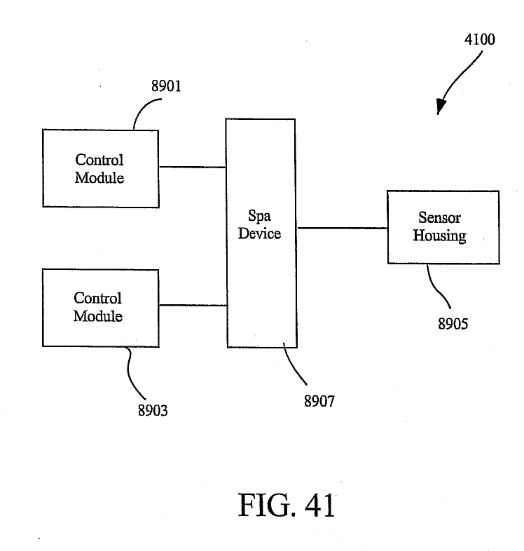

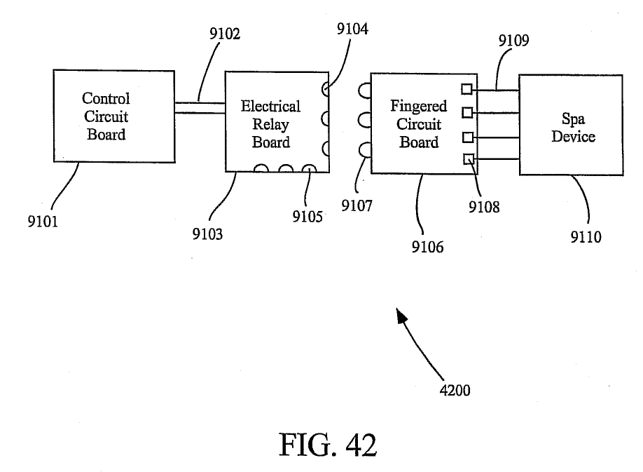

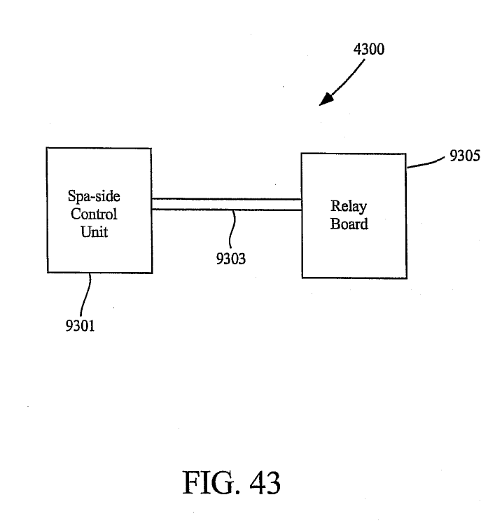

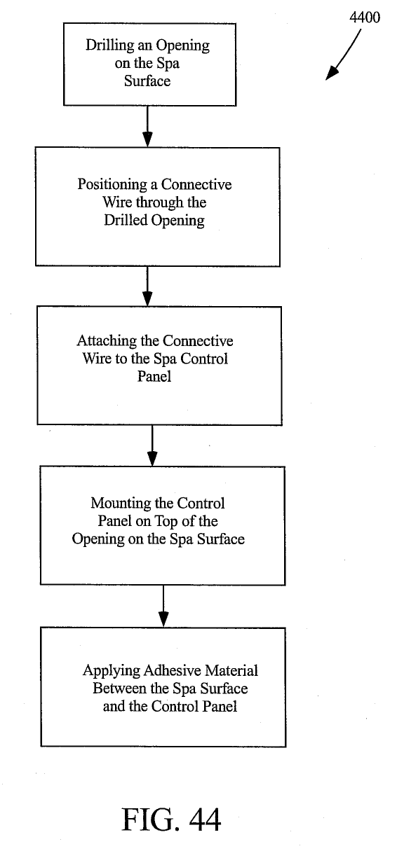

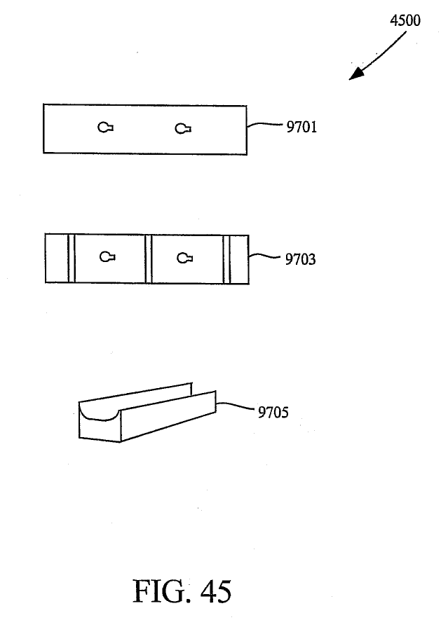

The high limit sensor 3702 in conjunction with the processor 3705 provides a safety shutoff to the spa water heater device when a predetermined high temperature is reached. The temperature sensor 3702, 3703 provides temperature readings for the spa water heater device. Both are placed in one housing unit 3701 thereby making replacement of the sensors easier than replacing two separately. In another embodiment of the invention, the spa control system as illustrated in FIG. 20 provides that if the readings of the two sensors are five degrees or more apart the processor will activate an indicator on the user interface to replace the sensor housing that contains the 2 sensors. This spa control system provides an efficient way to replace sensors and provides a self-check mechanism for the sensors.

Referring to FIG. 21, there is shown a spa control system 2100 that provides a temperature amount data representing a temperature amount of the main spa body water based on temperature amount data of a spa water heater. The control panel driven by a processor will display a temperature of the main spa body water after running the heater pump for some seconds and a temperature sensor provides a reading of delta temperature/delta time equals zero (when temperature in heater unit is not changing it means temperature of water in spa is the same as the temperature of the water in the heater). A last detected temperature after a heat cycle will be displayed and will be reduced by one degree per hour (based on hysterisis a main spa water temperature cools one degree per hour for the first two hours).

In addition, the temperature at 2 hours, 6 hours, and 12 hours after a heat cycle will be recorded. If the recorded temperature at 2 hours after a heat cycle is more than 4 degrees from the last recorded temperature or the recorded temperature at 12 hours after a heat cycle is more than 8 degrees from the last recorded temperature—the one degree per hour will be adjusted via software according to an average actual data recorded for 3 previous cycles.

Referring to FIG. 22, there is shown a spa control system 2200 for detecting a presence of a first pump and activating a second pump when the first pump is not present or is not operational. As illustrated in FIG. 22, at the start of each heat cycle a first pump, a low flow pump relay board switch is closed to allow low flow pump operation for filtration and bringing water to a spa water heater. A pressure switch or a temperature sensor in conjunction with a processor detects if water is present in the heater (if using a temperature sensor the temperature should rise briefly and then fall). If the presence of water is not detected the processor will activate a second pump, a high flow pump, by closing a high flow pump relay board switch. If water presence is still not detected in the spa water heater then the processor will disable the spa water heater and provide a user interface data representing the two pumps have failed.

Referring to FIG. 23, there is shown a spa control system 2300 for reducing a spa water heater power. One application for this spa control system is in environments where the maximum current requirement of the spa system exceeds the maximum available current, such as for example where a number of pumps, e.g. two or three, a blower, and a spa water heater may be operating (or not) at any given time. As illustrated in FIG. 23, a 240-VAC heat cycle is reduced to a 120-VAC heat cycle when a processor, coupled to an incoming power line, detects that the current flow amount is not sufficient to operate the pump or pumps along with a 240-VAC powered spa water heater. In this case when the current requirement exceeds an amount that is available to operate the pump or pumps, and blower, the spa water heater is reduced to 120-VAC. In the event the current requirements to operate the pumps and/or blower and the 120 VAC spa water heater exceeds the amount of current available, the spa water heater is then shut-off altogether.

Referring to FIG. 24, there is shown a spa control system 2400 utilizing a portable device 4705 with circuitry adapted to receive power from a remote source over a communication link 4711 and provide signals to a remote processor over the communication link 4711. Shown is a remote processor 4701, an antenna that provides a communication link 4703, a portable device 4705, a display panel 4709, and a user manipulatable trigger 4707.

The portable device 4705 contains circuitry adapted to receive power from a remote source 4701 over a communication link 4711 and provide signals to a remote processor over the communication link 4711, the signal may be of a spa device operation or a security access code that activates the spa control system. In some embodiments of the invention, the portable device 4705 can comprise a display 4709 and/or user manipulatable triggers 4707. Exemplary portable devices that are available but not yet utilized in spa control systems are a RF (radio frequency card), a Proximity Card, and the Smart Card. At the present time none of the available cards employ user manipulatable triggers.

Referring to FIG. 25-FIG. 26, there is shown a spa control system 2500-2600 for providing freeze protection to spa devices 4904. Shown is a processor 4901, a temperature sensor 4902, a spa water heater 4903, a spa device 4904, a memory device 4905, a user interface 5101, a indicator that freeze protect is available 5102, and a user manipulatable switch 5103. The processor is coupled to a temperature sensor 4902 and memory device 4905. The temperature sensor 4902 is placed in or near a spa water heater 4903 and is coupled to a memory device 4905. The spa water heater 4903 and the spa device 1904 are coupled to the processor 4901. In another embodiment of the invention, a user interface 5101 is coupled to the processor (not shown in FIG. 25).

A temperature sensor 4902 in or near the spa water heater 4903 provides a measured temperature amount representing a measured temperature amount of the spa water heater when the spa water heater 4903 is off. A memory device 4905 may be used to store the temperature amount data. If the processor 4901 determines the measured temperature amount is equal to or below a predetermined amount, usually a temperature that would cause a spa device to freeze, the processor 4901 will activate each pump once at the start of the heat cycle for a period of time to allow the spa device 4904 to avoid a freeze condition. In another embodiment of the invention, the processor 4901 is adapted to provide a user interface a signal indicating a freeze condition 5102 and the user manipulatable trigger 5103 can activate a spa device at a predetermined low operating speed for an indefinite time, or until deactivated by a user, to avoid a freeze condition.

Referring to FIG. 27 -28, as illustrated in FIG. 27 there is shown a spa control system 2700, 2800 for disabling a pump when a spa water heater is inactive and a temperature of a main body spa water exceeds a set temperature amount or increases at a predetermined rate. A processor coupled to a temperature sensor is adapted to disable a pump when the spa water heater is inactive and the temperature sensor detects that a temperature amount of the main body spa water is two degrees or more than the temperature amount for the main body spa water set by a user. The processor is further adapted to activate a disabled pump after a predetermined time period, preferably two hours, or when a heat cycle begins, or after a power interruption. As illustrated in FIG. 28 the pump that is disabled can be a filtration pump that is operating on a forced filtration cycle.

In addition to heater housing to be constructed of Nema Plastic or other acceptable material that is high temperature resistant, the spa control system can utilize electronics to prevent an overheating situation that may cause damage to a spa water heater housing, spa devices, and injury to a user of a spa.

Referring to FIG. 29-35, there is shown various embodiments of a spa control system for preventing an overheating of the main body spa water and/or spa device situation. Referring to FIG. 29 shown is a user interface 5701, an indicator that a high limit has been tripped 5702, a processor 5703, an incoming power line 5704, an electrical relay board 5705, a relay board switch 5706, a spa water-heater 5707, and a temperature sensor 5708. The user interface 5701 is coupled to the processor 5703, the processor 5703 is coupled to the incoming power line 5704 and the electrical relay board 5705, the temperature sensor 5708 is coupled to the processor 5703 and placed in or near the spa water heater 5707, and the spa water heater 5707 is coupled to the processor 5703.

In one embodiment, as illustrated in FIG. 30, upon each initiation of a heat cycle, the spa water heater 5707 is activated by the processor 5703 closing the electrical relay switch 5706, and then the temperature sensor 5708 provides a measured temperature amount representing the temperature amount of the spa water heater 5707. If the change in the temperature amount data versus a change in time (dt/dt) does not increase sharply in this brief time period the processor 5703 will leave the switch 5706 closed in the electrical relay board 5705 and allow the current to flow to the spa water heater 5707. The temperature amount of the spa water heater 5707 is continuously monitored and so long as there is no sharp increases in dt/dt, or the temperature amount data is below 120 degrees Fahrenheit, then the switch 5706 remains closed and the spa water heater 5707 continues to operate. However, if during the initial testing period or during the continuous operation of the spa water heater 5707 dt/dt shows a sharp increase the relay switch 5706 is opened and the processor 5703 will activate a high limit problem indicator 5702 on the user interface 5701.

In another embodiment, as illustrated in FIG. 31, the processor is adapted to initially activate the spa water heater for only a brief amount of time, preferably three seconds, again the heater may be activated by the processor closing the electrical relay switch. The temperature sensor provides a temperature amount data representing the temperature amount of the spa water heater, and if the change in temperature amount data versus a change in time (dt/dt) does not increase sharply in this brief time period, or the temperature amount data rises two to five degrees Fahrenheit and then falls, the processor will again close the switch in the electrical relay board and allow the current to flow to the spa water heater. However, if during the initial testing period or during the continuous operation of the spa water heater dt/dt shows a sharp increase or the temperature amount data does not fall the relay switch will remain open and the processor will activate a high limit problem indicator on the user interface. In addition if dt/dt was equal to zero then the processor will activate a sensor malfunction indicator on the user interface.

In yet another embodiment, as illustrated in FIG. 32, the processor is adapted to begin a heat cycle at a lower power level, preferably 120-VAC, the temperature sensor provides a temperature amount data representing the temperature amount of the spa water heater, and if the change in temperature amount data versus a change in time (dt/dt) does not increase sharply in this brief time period, or the temperature amount data rises two to five degrees Fahrenheit and then falls (indicating the presence of a water in the spa water heater), the processor is adapted to then increase the power level, preferably 240-VAC. However, if during the initial testing period or during the continuous operation of the spa water heater dt/dt shows a sharp increase or the temperature amount data does not fall the processor is adapted to disable the spa water heater and the processor will activate a high limit problem indicator on the user interface.

In yet another embodiment, referring to FIG. 33, there is shown a spa control system 3300 for reducing a heater power when a measured temperature amount representing a temperature of the spa water heater is equal to or above a predetermined amount. Shown is a user interface 6901, an indicator that a high limit has been tripped 6902, a processor 6903, a first incoming power line 6911, a neutral line 6905, a first electrical relay board 6906, a second electrical relay board 6907, a spa water heater 6908, a temperature sensor 6909, a thermostat electrical relay board 6910, and a first incoming power line 6911.

The user interface 6901 is coupled to the processor 6903, the processor 6903 is coupled to the first 6906 and second electrical relay board 6907, the spa water heater 6908 is coupled to the first electrical relay board 6906 and second electrical relay board 6907 and the processor 6903, the temperature sensor 6909 is coupled to the processor 6903 and placed in or near the spa water heater 6908, the first electrical relay board 6906 is coupled to the second incoming power line 6904 and the neutral line 6905, the second electrical relay board 6907 is coupled, in series, to the thermostat electrical relay board 6910 and to the first incoming power line 6911.

During a spa water heater on cycle, the spa water heater 6908 draws power from both the first electrical relay board 6906 and the second electrical relay board 6907. However, the processor 6903 is adapted to disable the first electrical relay board 6906, by having the first electrical relay board 6906 see the neutral line 6905, when the temperature sensor 6909 detects a rate of change of a measured temperature amount exceed a predetermined rate of change amount in the temperature of the heater unit. This spa control system reduces the power that the spa water heater 6908 is able to draw and thus reduces the heat to 1.5 Kilowatts.

In another embodiment, as illustrated in FIG. 34 and FIG. 35, there is shown a spa control system 3400, 3500 utilizing a temperature sensor 7104 in conjunction with a software time clock 7102. Shown is a control unit 7101 comprising a software time clock 7102 and a processor 7103, a temperature sensor 7104, and a spa water heater 7105. The control unit 7101, comprising a software time clock 7102 and a processor 7103, is coupled to the temperature sensor 7104 and the spa water heater 7105.

The software filter time clock 7102, preferably a 24 Hour software filter time clock, in conjunction with the processor 7103 activates both the filter cycle and the heat cycle by activating the heater pump and the spa water heater 7105 for a predetermined period. However, the processor 7103 is adapted to activate a spa water heater based on the software time clock only if the temperature sensor provides a temperature amount data representing a temperature of the spa water heater, at the start of the filter cycle, that is below a set temperature for the spa. Otherwise only the heater pump will operate.

Referring to FIG. 36 and FIG. 37, there is shown a spa control system 3600, 3700 for activating a spa water heater on cycle by actuating any user manipulatable triggers 7502. Shown is a user interface 7501, a plurality of user manipulatable triggers 7502, a processor 7503, and a spa water heater 7504. The user interface 7501 is coupled to the processor 7503, the processor 7503 is coupled to the spa water heater 7504.

The processor 7503 is adapted to activate a spa water heater 7504 when the processor 7503 detects a signal indicating a user manipulation of any of the user manipulatable triggers 7502 on the user interface 7501. As illustrated in FIG. 37, if there is already a spa water heater on cycle when the processor 7503 detects the signal indicating a user manipulation of the user manipulatable trigger 7502, the processor 7503 will activate the spa water heater 7504 when a current cycle ends.

Referring to FIG. 38, there is shown a spa control system 3800 for utilizing an ambient temperature to manage spa temperature. As illustrated in FIG. 79, a filtration pump can be used to circulate a spa water during a time of the day when the temperature is the highest to warm up the spa in a cold weather environment, or when the temperature is lowest to cool off the spa in a warm weather environment.

Utilizing a temperature sensor operative to provide a temperature amount data representing a temperature amount of a surrounding environment when a spa water heater is inactive, a memory device operative to record the temperature amount data of the spa water heater for a predetermined time period, and a processor adapted to activate the filtration pump the next day at the same time period when a predetermined temperature amount data was recorded on, a user can manage the spa temperature more efficiently and more cost effectively. The temperature amount may represent a temperature of the ambient air if the temperature sensor is adapted to detect a temperature of the ambient air, or the temperature amount may represent a temperature of the spa water heater if the temperature sensor is adapted to detect a temperature of the spa water heater.

Referring to FIG. 39, there shown is a spa control system for utilizing ambient air temperature to cool a main spa body water. Shown is a main spa body water 8501, a temperature sensor 8502, a blower 8503, and a processor 8504. The processor 8504 is coupled to the temperature sensor 8502, the blower 8503 is coupled to the processor 8504.

The spa control system utilizing a blower 8503, a temperature sensor 8502 operative to provide a measured temperature amount representing a temperature amount of a main spa body water, and a processor 8504 that is adapted to activate the blower 8503 at predetermined time periods, or the blower 8503 can be activated when the measured temperature amount exceeds a preset spa temperature amount. This embodiment of the invention enables a user to use a cooler ambient air as well as evaporation to cool a spa.

Referring to FIG. 40, there shown is a spa control system 4000 for utilizing a 240 VAC coiled relay 8702 to ensure proper power connections are made. Shown is an incoming power line 8701, a 240 VAC coiled relay 8702, and a spa control unit 8703. The 240 VAC coiled relay 8702 is coupled to the incoming power line, and the spa control unit 8703 is coupled to the 240 VAC coiled relay 8702.

The spa control system utilizes a 240-VAC coiled single pole double throw relay 8702, coupled to the incoming power line 8701, to prevent a 120-VAC power connection to a spa control unit 8703. This system enables the user or an electrician to detect if a correct power connection has been made.

Referring to FIG. 41, there shown is a spa control system 4100 for utilizing a user replaceable control system parts. Shown is a first control module 8901, a second control module 8903, a sensor housing 8905, and a spa device 8907. The first control module 8901 is coupled to a spa device 8907, the second control module is coupled to a spa device 8907, and a sensor housing is coupled to a spa device. Each module is adapted to be easily accessible and replaceable by a user.

Referring to FIG. 42, there shown is a spa control system 4200for utilizing electrical circuit boards 9106 and electrical relay boards 9103 to reduce the amount of connective wiring. The exemplary embodiment enables a connection of spa devices outside of the control circuit board, therefore easier connections can be made with less risk of damage to a control circuitry. Shown is a control circuit board 9101, a conductive wire 9102, a slotted electrical relay board 9103, a plurality of slots 9104 and 9105, a fingered circuit board 9106, a plurality of fingers 9107, a receptacle mounted on the fingered electrical circuit board 9106, a conductive wire 9109, and spa device 9110. The control circuit board 9101 is coupled to the slotted electrical relay board 9103, the slotted electrical relay board 9103 is coupled to the control circuit board 9101, the fingered circuit board 9106 is coupled to the slotted electrical relay board 9103, the spa device is coupled to the receptacle mounted 9108 on the fingered electrical circuit board 9106.

As illustrated in FIG. 42, by utilizing a fingered electrical circuit board 9106 with mounted receptacles 9108, the receptacles 9108 adapted to provide an electrical current to an electrically connected spa device 9110 and adapted to engage a multitude of plugs and connectors, the fingers 9107 of the fingered circuit board 9106 adapted to receive an electrical current, the electrical relay board slots 9104 adapted to engage the fingers 9107 of the electrical circuit board 9106, and a control circuit board 9101 coupled to the electrical relay board 9105, and can be contained in a control housing, wherein the control circuit board 9101 is adapted to provide an electrical current to the electrical relay board 9103, thereby reduces the number of wires needed to connect various spa devices and enable a connection external to the control circuit board housing.

Referring to FIG. 43, there shown is a spa control system 4300 for utilizing a four wire serial data cable 9303 to connect a control unit 9301 and an electrical relay board 4305. Shown is a control unit 9301, a four wire serial data cable 9303, and an electrical relay board 9305. The control unit 9301, is coupled to an electrical relay board 9305 through a four wire serial data cable 9303. The four wire serial data cable 9303 is operative to provide a ground, a voltage for power, and a digital communication link and is not presently used in spa control systems.

Referring to FIG. 44, there shown is an exemplary process for mounting a spa control panel onto a spa surface. The steps involved are as follows: drilling an opening on the spa surface, positioning a connective wire through the opening, attaching the connective wire to the spa control panel, mounting the control panel on top of the opening on the spa surface; and applying adhesive material between the spa surface and control panel.

Referring to FIG. 45, there shown is an apparatus for mounting a spa water heater. Shown is a top view of a keyed mount 9701, a bottom view of the keyed mount 9703, and a perspective view of the same keyed mount 9705.

Referring first to the top view 9701, shown is an upper arcuate surface, a first keyhole, and a second keyhole. The upper arcuate surface is designed match with a water heater unit for use in a spa system. The water heater unit can be mounted to the upper arcuate surface in numerous ways for example, by gluing, welding, fasteners, with metal strapping, or merely placing a spa water heater and any number of other well-known suitable mechanisms for mounting.

The first keyhole and the second keyhole are sized to accept mounting screws as is well-known. In operation, the mounting apparatus is lowered over first and second mounting screws such that the first and second mounting screws engage the first and second keyholes. Once the mounting screws enter the first and second keyholes and a lower surface of the mounting apparatus has become flush with a service to which the water heater is to be mounted, the mounting apparatus is shifted, for example, to the left, as oriented in FIG. 97, as to engage the heads of the screws against the keyholes thereby preventing the raising of the +mounting apparatus off of the mounting screws.

Referring next to the bottom view 9703, a lower surface of the mounting apparatus is shown. Also shown is the first keyhole and the second keyhole. As described above, the lower surface engages a surface to which the water heater is to be mounted prior to the shifting of the water heater and mounting apparatus, so as to engage the first and second screws with the first and second keyholes.

Referring next to the perspective view 9705, shown is the mounting apparatus, including the upper arcuate surface against which the water heater is engaged prior to the mounting of the mounting apparatus to the surface. Preferably, the mounting apparatus may be made from, for example, plastic or metal.

What is claimed is:

1. A spa control system, the spa control system comprising:
a filtration pump;
a temperature sensor operative to provide a temperature amount data representing a temperature amount of a surrounding environment when a spa water heater is inactive;
a memory device operative to record the temperature amount data of the spa water heater for a predetermined time period;
a processor coupled to the memory device and the filtration pump, wherein the processor is adapted to activate the filtration pump the next day at the same time period when a predetermined temperature amount data was recorded.

2. The spa control system of claim 1, wherein the surrounding environment is a spa water heater housing;

3. The spa control system of claim 1, wherein the surrounding environment is an ambient air;

4. The spa control system of claim 1, wherein the predetermined temperature amount data is the least amount recorded during the predetermined time period.

5. The spa control system of claim 1, wherein the predetermined temperature amount data is the greatest amount recorded during the predetermined time period.

6. A spa control system, the spa control system comprising:
a blower;
a temperature sensor operative to provide a temperature amount data representing a temperature amount of a main spa body water;
a processor coupled to the blower and the temperature sensor, wherein the processor is adapted to activate the blower at predetermined time periods and when the temperature amount data exceeds a preset spa temperature amount.
